(19) United States
(12) Patent Application Publication
(10) Pub. No.: US 2015/0320086 A1
(43) Pub. Date: Nov. 12, 2015

(54) Microalgae Meal

(71) Applicant: Solazyme, Inc., South San Francisco, CA (US)

(72) Inventors: John Piechocki, South San Francisco, CA (US); Stephanie L. Hansen, Ames, IA (US); Daniel D. Loy, Ames, IA (US); Olivia Genther-Schroeder, Ames, IA (US); Rebecca Stokes, Ames, IA (US); Megan Van Emon, Ames, IA (US)

(21) Appl. No.: 14/706,862

(22) Filed: May 7, 2015

Related U.S. Application Data
(60) Provisional application No. 62/127,639, filed on Mar. 3, 2015.
(60) Provisional application No. 62/049,939, filed on Sep. 12, 2014.
(60) Provisional application No. 61/989,999, filed on May 7, 2014.

(51) Int. Cl. A23K 1/16; A23K 1/06; A23K 1/18

(52) U.S. Cl. CPC A23K 1/1646; A23K 1/1813; A23K 1/1893; A23K 1/06; A23K 1/1631

(57) ABSTRACT

Provided are animal feeds containing microalgae meal and methods for their use. The microalgae meal contains delipidated microalgal biomass and soy hulls.

### CROSS REFERENCE TO RELATED APPLICATIONS

This application claims the benefit under 35 U.S.C. 119(e) of U.S. Provisional Patent Application No. 61/989,999, filed May 7, 2014, U.S. Provisional Patent Application No. 62/049,939, filed Sep. 12, 2014, and U.S. Provisional Patent Application No. 62/127,639, filed Mar. 3, 2015, each of which is incorporated herein by reference in its entirety.

### BACKGROUND

Animal feed costs typically represent the greatest expense in animal farming and care. Particularly for livestock production, animal feed is often subject to seasonal price fluctuations. Use of alternative ingredients for partial replacement of traditional animal feeds such as corn and soy meal products can lower and promote stable operating expenses. Optimum animal health and growth with a minimum of food waste are characteristics of an affordable, high quality feed. A key contributing factor to high feed quality is voluntary feed intake, which is dependent on numerous factors including palatability and digestibility.

### SUMMARY

In one embodiment, the present invention provides a method for providing feed to an animal, the method comprising administering to the animal a feed comprising up to 65% microalgae meal, wherein the microalgae meal comprises delipidated microalgal biomass.

In another embodiment, provided is a method for increasing feed intake and weight gain in an animal, the method comprising administering to the animal a feed comprising up to 65% microalgae meal, wherein the microalgae meal comprises delipidated microalgal biomass, and wherein the feed intake increases with increasing microalgae meal content.

In some embodiments, the feed comprises from 45% to 65% microalgae meal. In some embodiments, the feed comprises up to 45% microalgae meal. In other embodiments, the feed comprises from 15% to 45% microalgae meal. In some embodiments, the feed comprises up to 30% microalgae meal. In other embodiments, the feed comprises up to 60% microalgae meal. In still other embodiments, the feed comprises at least 15% microalgae meal.

In some embodiments, the microalgae meal further comprises corn starch, potato starch, cassava starch, switchgrass, rice straw, rice hulls, sugar beet pulp, sugar cane bagasse, soybean hulls, dry rosemary, cellulose, corn stover, delipidated cake from soybean, canola, cottonseed, sunflower, jatropha seeds, paper pulp, or waste paper.

In some embodiments, the microalgae meal further comprises soybean hulls. In some embodiments, the soybean hulls comprise 5 to 50% by weight of the microalgae meal. In some embodiments, the soybean hulls comprise 25 to 45% by weight of the microalgae meal.

In some embodiments, the feed further comprises protein additives derived from non-microalgal sources. In some embodiments, the protein additive is yeast. In other embodiments, the yeast is hydrolyzed yeast. In some embodiments, the yeast is spent yeast recovered from fermentation. In some embodiments, the spent yeast was recovered from ethanol production fermentation.

In some embodiments, the animal is a livestock or companion animal. In some embodiments the animal is a ruminant. In some embodiments, the animals are cattle, swine, poultry, sheep, or goats. In some embodiments, the companion animal is a horse, rabbit, or dog. In some embodiments, the animals are cattle. In some embodiments, the animal is a calf.

In some embodiments, the feed further comprises corn, soybean, DDGS (dried distiller's grain with solubles), or one or more combinations thereof.

In some embodiments, the feed comprises at least 5%, 4%, 3%, or 2% moisture.

In some embodiments, the feed further comprises wet corn gluten feed, wet distillers grains, modified distillers grains, or one or more combinations thereof.

In some embodiments, the microalgae biomass is derived from a heterotrophically cultured microalgae. In some embodiments, the microalgae is of the genus Prototheca. In some embodiments, the microalgae is of the species Prototheca moriformis.

In some embodiments, the animal feed is a pellet.

In some embodiments, an animal fed on microalgae meal has a lower atherogenic index than when fed on corn.

In some embodiments, the microalgae meal comprises from 35% to 85% non-starch carbohydrates. In other embodiments, the microalgae meal comprises from 35% to 45% non-starch carbohydrates. In other embodiments, the microalgae meal comprises from 70% to 85% non-starch carbohydrates. In some embodiments the microalgae meal further comprises 5% to 15% fat and 4% to 15% protein.

### BRIEF DESCRIPTION OF THE DRAWINGS

FIG. 1 shows a timeline for the fourteen day periods for the in situ digestibility study as described in Example 3.

FIG. 2 shows comparisons of the dry matter intake as a percent of total feed offered for feeds containing varying amounts of microalgae meal as described in Example 2. Paired diet combinations included: 1) CON vs. A15, 2) CON vs. A30, 3) A30 vs. A45, 4) CON vs. A45, 5) A15 vs. A30, and 6) A15 vs. A45. Diet: P=0.006. Pair×Diet: P=0.01. ALG45 vs. ALG15 and ALG30 (*): P≦0.008.

FIG. 3 shows comparisons of the dry matter intake for feeds containing varying amounts of microalgae meal as described in Example 2. Paired diet combinations included: 1) CON vs. A15, 2) CON vs. A30, 3) A30 vs. A45, 4) CON vs. A45, 5) A15 vs. A30, and 6) A15 vs. A45. Diet: P=0.001. Pair×Diet: P=0.003. ALG45 vs. ALG15 and ALG30 (*): P≦0.004. CON vs. ALG30 (†): P=0.09.

FIG. 4 shows rates of the dry matter intake for feeds containing varying amounts of microalgae meal as described in Example 2. Diet×hour: P≦0.001. CON and A15 vs. A30 and A45 (*): P=≦0.02. A15 vs. A45 (†): P=0.01. CON, A15, and A30 vs. A45 (‡): P≦0.03. CON vs. A15 and A30 (¶): P≦0.06.

FIG. 5 shows percent dry matter digestibility for various feeds (algae meal, corn, hay, and soyhulls) over a 36 hour rumen incubation period as described in Example 3. Hour: P≦0.001. Diet×hour: P≧0.40.

FIG. 6 shows average daily dry matter intake by week of steers fed diets containing increasing concentrations of algae meal as described in Example 4. Diet: P<0.001. Week: P<0.001. Diet×week: P=0.005. ALGO vs. ALG30 (†): P≦0.04. ALGO, ALG15 vs. ALG30, ALG45 (*): P≦0.05. ALG45 vs. ALGO, ALG15 (¶): P≦0.002. ALG30 vs. ALG45 (∥): P=0.04.

### DETAILED DESCRIPTION

### Definitions

“Microalgae” are eukaryotic microbial organisms that contain a chloroplast or other plastid, and optionally that are capable of performing photosynthesis, or a prokaryotic microbial organism capable of performing photosynthesis. Microalgae include obligate photoautotrophs, which cannot metabolize a fixed carbon source as energy, as well as heterotrophs, which can live solely off of a fixed carbon source. Microalgae include unicellular organisms that separate from sister cells shortly after cell division, such as Chlamydomonas, as well as microbes such as, for example, Volvox, which is a simple multicellular photosynthetic microbe of two distinct cell types. Microalgae include cells such as Chlorella, Dunaliella, and Prototheca. Microalgae also include other microbial photosynthetic organisms that exhibit cell-cell adhesion, such as Agmenellum, Anabaena, and Pyrobotrys. Microalgae also include obligate heterotrophic microorganisms that have lost the ability to perform photosynthesis, such as certain dinoflagellate algae species and species of the genus Prototheca.

“Delipidated microalgal biomass” refers to residual material remaining after lipids have been extracted such as by pressing. “Biomass” is material produced by growth and/or propagation of cells including whole cells, whole cell debris, cell wall material, polysaccharides, triglycerides, proteins, and other intracellular or extracellular components. The biomass can also contain any materials present in the culture media, such as any sugar used to grow the cells.

“Sugar” in connection with algal feedstock refers to carbohydrates that are derived from natural sources or that are synthetically or semi-synthetically prepared. Sugar can be derived from natural sources such as through extraction (e.g. sugarcane or sugar beet) or by further chemical, enzymatic processing (e.g. sugar from corn), and/or by depolymerizaton of cellulosic materials. Sugar includes glucose and sucrose.

### Animal Feed

In some embodiments, microalgal cells are heterotrophically cultured according to standard methods such as those described in WO2008/151149, WO2010/063031, WO2010/063032, WO2011/150411, and WO2013/158938. The microalgal cells can be wild type cells or can be genetically or chemically modified to alter their fatty acid profile and/or lipid productivity. Upon cultivation, the cells can be subjected to further processing, including drying and/or concentration. The drying step may be achieved through drum drying, spray drying, freeze drying, oven drying, vacuum drying, tray drying, box drying, or through another method to dry the material.

The oil is extracted by mechanical pressing using soybean hulls as a press aid. The addition of a fibrous pressing aid helps extract the oil. Suitable pressing aids include, but are not limited to, corn starch, potato starch, cassava starch, switchgrass, rice straw, rice hulls, sugar beet pulp, sugar cane bagasse, soybean hulls, dry rosemary, cellulose, corn stover, delipidated (either pressed or solvent extracted) cake from soybean, canola, cottonseed, sunflower, jatropha seeds, paper pulp, waste paper and the like. In some embodiments, the spent microbial biomass of reduced lipid content from a previous press is used as a bulking agent.

The residual biomass material can be used as the microalgae meal or can be subjected to further processing. In some embodiments, the residual biomass may be optionally milled to provide particle size consistency or to further reduce particle size of the biomass. The milling may be achieved through jet milling, hammer milling, bead milling, pearl milling, or another other form of pulverization. The residual biomass may be fractionated to enrich in polysaccharides or to recover proteins, nutrients or other valuable components. Fractionation may comprise washing with a solvent, especially a polar solvent such as water, ethanol or other alcohol, or mixture thereof, and centrifugation or filtration to separate soluble from insoluble fractions.

The microalgae meal is combined with other animal feed ingredients to form the animal feed. Animal feed ingredients include corn and soymeal products for which the microalgae meal serves as a partial replacement. Animal feed ingredients can also include any feed additives. The additives can provide nutrients, flavoring, texturing, fiber, moisture and/or stability to the feed. The animal feed can also be shaped into pellets.

Delipidated microalgae, when combined with soyhulls, offers a unique combination of fiber, protein, and fat to serve as an alternative feedstuff for ruminants. The ruminant diet can directly influence the carcass characteristics of that animal. This overall carcass quality not only impacts the producer's bottom line, but also relates directly to consumer demand and the ability to provide a consistent, palatable product. The ruminant animal, with their unique capability to convert what would otherwise be waste products into nutritious animal protein via fermentation, is an ideal target for consumption of this coproduct. Feedlot cattle represent a ready market for large quantities of algae meal. Algae meal may serve as a potential substitute for corn, which is the basis for many feedlot diets worldwide; consequently contributing to global nutritional security for both humans and animals.

The following examples illustrate, but do not to limit, the claimed invention.

### EXAMPLES

UTEX 1435, a Prototheca microalgae, was classically mutagenized for higher oil production and further transformed with a construct for production of triacylglycerides with high oleic acid and low linoleic acid profile. The construct disrupts a single copy of the FATA1 allele while simultaneously expressing a Saccharomyces cerevisiae sucrose invertase and overexpressing a P. moriformis KASII gene (PmKASII). The microalgae were cultured under heterotrophic conditions such as those described in WO2008/151149, WO2010/063031, WO2010/063032, WO2011/150411, and WO2013/158938. Upon cultivation, the fermentation broth was concentrated by evaporation, dried using a drum dryer, de-lumped, and finely ground to less than 3500 microns. The resulting solids were combined with approximately 30% by weight of soyhulls and pressed with a screw press to release and separate the oil from the microalgae meal. The resulting presscake contains approximately 43% by weight soyhulls and 57% by weight of the partially delipidated microalgae and residual fermentation culture ingredients. The microalgae meal utilized in Examples 1, 2, and 3 was from lot number ML674, and lot number ML718 was used for Example 4. The term algae meal refers to a microalgae meal; these terms are used interchangeably in this application.

### Example 1

### In Vitro Digestibility

An in vitro digestibility study (Dairyland Laboratories, Inc.) was conducted to determine the dry matter (DM) digestibility of algae meal (Table 1) compared with hay and soyhulls. Three fistulated steers (998±103 kg body weight) were transitioned from a roughage-based diet over a period of 4 weeks to a concentrate-based control diet (Table 2). The in vitro digestibility study was conducted using a Daisy II Incubator (Ankom Technology; Macedon, N.Y.). The protocol utilized in this study was similar to that outlined in the In Vitro True Digestibility protocol provided by Ankom Technology. The methodology of the Daisy II Incubator has been previously described and verified by Robinson et al. (Robinson, P. H., M. Campbell Mathews, and J. G. Fadel. 1999; Influence of storage time and temperature on in vitro digestion of neutral detergent fibre at 48 h, and comparison to 48 h in sacco neutral detergent fibre digestion; Anim. Feed. Sci. Tech. 80:257-266) and Spanghero et al. (Spanghero, M., S. Boccalon, L. Gracco, and L. Gruber. 2003, NDF degradability of hays measured in situ and in vitro; Anim. Feed Sci. Tech. 104:201-208).

Briefly, the algae meal, hay, and soyhulls were dried at 70° C. for 48 hours and ground to pass through a 2-mm screen. Each feedstuff was weighed into filter bags (0.5±0.001 g; F57; 25 micron porosity; Ankom Technology; Macedon, N.Y.). Two buffer solutions (A and B) were prepared based on the Ankom protocol and were equilibrated to 39° C. Buffer solutions A and B were mixed together in a 5:1 ratio at 39° C. until a final pH of 6.8 was achieved. The total volume of the A:B solution added to each incubation jar was 1600 mL. Once the buffer solution was added to each incubation jar, each feedstuff was placed in triplicate into each of the four incubation jars. The jars were placed in the Daisy II Incubator to equilibrate for 30 minutes.

One 2 L thermos bottle was preheated with 39° C. water. Immediately prior to rumen fluid collection, the heated water was removed from the thermos bottle and the rumen fluid of each fistulated steer was collected directly into separate thermos bottles. To ensure adequate mixing across steers, a total of 600 mL of rumen fluid was collected from each steer (n=3). The rumen fluid was strained through 4 layers of cheesecloth and 400 mL of the mixed rumen fluid was added to each of the temperature equilibrated incubation jars. Each incubation jar was then purged with CO₂ for thirty seconds. Samples were incubated at 39.5±0.5° C. for 24 and 48 hours in each incubation jar. This resulted in 12 bags of each feedstuff and an n of 4 for each feed sample for each time point.

Once the incubation periods were completed, the samples were removed from the incubation jars and rinsed with cold tap water 10 times, which ensured the rinse water ran clear. Samples were then blotted to remove excess water and were placed in a forced air oven at 70° C. for 48 hours. Once samples were dried, they were removed from the oven and weighed. To calculate DM digestibility (%) the following equation was used:

(Initial Sample Wt.−Final Sample Wt./Initial Sample Wt.)×100

TABLE 1
Nutrient composition of the algae meal.

| Item | ML6742 | ML7182 |
|---|---|---|
| Dry matter, % | 98.61 | 96.15 |
| Moisture, % | 1.39 | 3.85 |
| | DM basis | DM basis |
| Crude protein, % | 9.94 | 9.20 |
| Neutral detergent fiber, % | 34.20 | 37.86 |
| Fat, % | 7.15 | 7.54 |
| Ash, % | 6.21 | 5.73 |
| Non fibrous carbohydrates, % | 42.50 | 39.67 |
| Calcium, % | 0.33 | 0.40 |
| Phosphorus, % | 0.32 | 0.23 |
| Magnesium, % | 0.35 | 0.30 |
| Potassium, % | 1.96 | 1.88 |
| Sulfur, % | 0.59 | 0.43 |
| Sodium, % | 0.14 | 0.14 |
| Manganese, mg/kg | 13 | 51 |
| Zinc, mg/kg | 81 | 74 |
| Copper, mg/kg | 5 | 8 |
| Iron, mg/kg | 686 | 480 |
| Molybdenum, mg/kg | 2.96 | 2.07 |

The neutral detergent fiber is attributed primarily to soyhulls which comprise approximately 43% of the presscake. Addition of lower amounts of soyhulls (less than 30% before pressing) will result in an increase in the percentage of non-fibrous carbohydrates.

### Example 2

### Diet Preference

To determine if cattle readily eat diets containing relatively large percentages of the algae meal, the same 3 fistulated beef steers from Example 1 were used to determine the preference of the algae meal at four different inclusions. There were four dietary treatments (Table 2): 1) the control diet with no algae meal (CON), 2) 15% inclusion of the algae meal as a direct replacement of corn on a DM basis (A15), 3) 30% inclusion of the algae meal (A30), and 4) 45% inclusion of the algae meal (A45). Diets were formulated to meet or exceed nutrient requirements of the fistulated steers (NRC. 1996. Nutrient requirements of beef cattle. 7th rev. ed. Natl. Acad. Press, Washington, D.C.). Diets were mixed once weekly and stored in 208.2 L barrels. This experiment was conducted as a 3×6 Latin Square involving 6 periods lasting 5 days each, and 4 dietary treatments offered as 6 possible paired treatment combinations (CON vs. A15, CON vs. A30, CON vs. A45, A15 vs. A30, A15 vs. A45, or A30 vs. A45). Steers were housed in individual pens (3.7 m×12.2 m) to determine the preference of each steer to the four diets. Steers had ad libitum access to water. Diets were separated within each bunk by a wooden barrier and fed in 24.6 L feed tubs (45.7×45.7×20.3 cm) to limit the likelihood that steers could mix the 2 offered diets.

Steers were acclimated to the individual pens and feeding style with a barrier in each bunk for 7 days prior to the initiation of the experiment. During the acclimation period, the CON diet was fed in equal portions in both feeding compartments. Days 1 to 3 in each period were to serve as an acclimation period to the CON diet and individual feeding. On day 4, steers were offered two of the diets, one in each feeding compartment. Each diet was initially offered at 25% of the day's total feed delivery, which was a total of 50% of the day's total feed offered (as fed basis) as the experimental diets. Bunks were monitored at 1, 2, 3, and 4 hours post-feeding to determine the preference of each steer. Steer preference was determined based on DM disappearance for the 4 hours immediately post-feeding. At the end of the one hour periods, the orts (feed refusals) from each diet were weighed to determine feed intake. If less than 3.6 kg of feed remained in the feed tub, additional feed was offered at 2.3 kg increments until the 3.6 kg threshold was met. This ensured that each diet was always available for consumption throughout the 4 hour period. At the end of the 4 hour data collection period, experimental diets were removed from the bunks, sampled, and discarded. Steers were then offered their remaining feed (as fed basis) as the CON diet for the day. To eliminate any preference for feed delivered on the right side of the bunk verses the left side of the bunk, the comparison was repeated on day 5 of each period, with diets offered on the opposite side of the bunk from day 4. Dietary and water preference trials have been conducted previously using a similar technique to the current experiment (Genther, O. N., and D. K. Beede. 2013, Preference and drinking behavior of lactating dairy cows offered water with different concentrations, valences, and sources of iron, J. Dairy Sci. 96:1164-1176; Pfister, J. A., T. Z. Davis, and J. O. Hall. 2013, Effect of selenium concentration on feed preferences by cattle and sheep, J. Anim. Sci. 91: 5970-5980). Dietary and orts samples were dried in a forced air oven at 70° C. for 48 h in order to calculate DM intake (DMI) of each steer for each diet.

TABLE 2
Dietary ingredient and calculated nutrient composition
of the concentrate-based control diet in Examples
1-3 and the diets in Examples 2 and 3.

| | Dietary treatment | | | |
|---|---|---|---|---|
| Item | CON | A15 | A30 | A45 |

Ingredient, % DM basis

| | | | | |
|---|---|---|---|---|
| Cracked corn | 61 | 46 | 31 | 16 |
| Chopped bromegrass hay | 12 | 12 | 12 | 12 |
| DDGS | 24.93 | 24.93 | 24.93 | 24.93 |
| Algae meal | 0 | 15 | 30 | 45 |
| Trace mineral premix | 0.026 | 0.026 | 0.026 | 0.026 |
| Calcium carbonate | 1.62 | 1.62 | 1.62 | 1.62 |
| Vitamin A premix3 | 0.10 | 0.10 | 0.10 | 0.10 |
| Salt | 0.31 | 0.31 | 0.31 | 0.31 |
| Rumensin ®90 | 0.014 | 0.014 | 0.014 | 0.014 |

Nutrient composition (calculated)

| | | | | |
|---|---|---|---|---|
| Dry matter, % | 89.5 | 90.6 | 92.3 | 93.4 |
| Crude protein, % of DM | 13.9 | 13.9 | 13.9 | 13.9 |
| Fat, % of DM | 5.4 | 5.8 | 6.3 | 6.7 |
| NDF, % of DM | 22.5 | 26.3 | 30.1 | 33.9 |

Dietary treatment: CON: the control diet with no algae meal, A15: 15% inclusion of the algae meal as a direct replacement of corn on a DM basis, A30: 30% inclusion of the algae meal, and A45: 45% inclusion of the algae meal.
Trace mineral premix provided per kilogram of diet: 30 mg Zn as ZnSO₄, 20 mg Mn as MnSO₄, 0.5 mg I as Ca(IO₃)₂(H₂0), 0.1 mg Se as Na₂SeO₃, 10 mg Cu as CuSO₄, and 0.1 mg Co as CoCO₃.
Vitamin A premix contained 4,400,000 IU/kg.

Rumensin®90: Provided 200 mg-1·steer-1·day of the ionophore monensin (Elanco Animal Health, Greenfield, Ind.).

### Example 3

### In Situ Digestibility

Upon completion of the in vitro digestibility study and palatability experiment, an in situ digestibility study was conducted with the same 3 fistulated (998±103 kg body weight) steers from Ex. 1 and 2. For this study, an unbalanced 3×4 Latin Square design was used. As described in Ex. 2, there were four dietary treatments (Table 2): 1) the control diet with no algae meal (CON), 2) 15% inclusion of the algae meal as a direct replacement of corn on a DM basis (A15), 3) 30% inclusion of the algae meal (A30), and 4) 45% inclusion of the algae meal (A45). Diets were mixed once weekly and stored in 208.2 L barrels. Feed samples of each diet were collected each week and dried in a forced-air oven at 70° C. for 48 hours to determine DMI. Steers were housed in individual pens (3.7 m×12.2 m) to determine DMI of each steer and steers had ad libitum access to water. Body weight of the steers was collected on day 1 of each period. Steers were limit fed at 2% of their body weight (BW) on a DM basis, which was adjusted on day 1 of each period. There were 4 periods, with each fistulated steer (n=3) receiving each of the dietary treatments, this resulted in each treatment being replicated three times throughout the 4 periods. Each period was 14 days long, to allow for 12 days of adaptation to the dietary treatment, with Dacron bags being inserted on day 13. Dry matter intake was monitored daily during each period throughout the experiment.

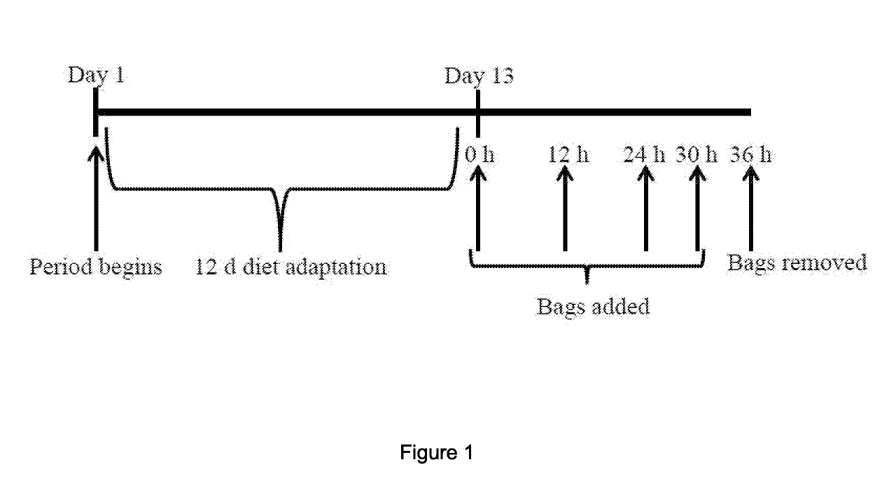

Digestibility of bromegrass hay, corn, algae meal, and soyhulls samples were determined. Similar to Ex. 1, each feedstuff was dried in a forced air oven at 70° C. for 48 h and ground to pass through a 1-mm screen. Ground corn, algae meal, and soyhulls were weighed into separate 5×10 cm Dacron bags (1.0±0.001 g; R510; Ankom Technology) and hay was weighed into 10×20 cm Dacron bags (4.0±0.001 g; R1020; Ankom Technology). Each filter bag has a 50 micron porosity that allows rumen bacteria to freely enter and exit the bag, but does not allow the escape of feed particles until bacteria have digested feed enough to pass out of the bag. Duplicate samples of each feedstuff were placed within the rumen at 0, 12, 24, and 30 hour to determine DM disappearance (FIG. 1). For each time point, 12 total bags were added, 4 blank bags and 2 bags for each feedstuff (8 total bags), and all bags were removed at 36 h. Rumen pH was measured at 6 h post-feeding on day 14, which coincided with the 6 h incubation time. This allowed determination of the rate of DM disappearance of the algae meal and comparative feedstuffs over a series of time points to provide information on its potential digestibility in the rumen environment over time.

### Example 4

### Starter Calf Study

A starter calf trial was conducted to determine growth performance and DMI of starter calves fed diets with increasing concentrations of algae meal. Sixty-three steer calves were purchased from a local auction market in Iowa. Calves were rested in two pens and fed a common receiving diet (Table 3). All steers were initially weighed on days −11 and −10 and 48 steers were selected based on weight, health, and temperament and allotted to one of eight feedlot pens equipped with GrowSafe units (n=6 steers per pen). Steers were fed a common diet and began a series of three 2 or 3 day step-up diets (Table 3) where wet corn gluten feed (WCGF) gradually replaced bromegrass hay in preparation for the experimental diets. Prior to beginning the study, steers were adapted and trained to utilize the individual intake system for the 10 days prior to treatment initiation (day −10 to 0). Steers were stratified by initial body weight (day −11 and −10) into one of four dietary treatments (Table 4): 1) a control wet corn gluten feed-based diet with no algae meal inclusion (CON; n=12 steers); 2) 15% algae meal (ALG15; n=12) which replaced wet corn gluten feed on a DM basis; 3) 30% algae meal (ALG30; n=12); and 4) 45% algae meal (ALG45; n=12). The diets began on day 1, the trial lasted 56 days, and utilized 48 steers (292±22.4 kg). All 48 steers were fitted with a unique electronic identification tag, which allows the GrowSafe-equipped bunks to record feed consumed by each animal. Dietary composition and algae inclusion rates were chosen based on the preliminary preference results from Ex. 2. Steers were weighed on consecutive days at the start (day 0 and 1) and end (day 55 and 56) of the trial, and at 26 and 27 days (mid-point weights). Individual intake and feed efficiency (G:F) of each steer was calculated. Upon completion of the experiment, the steer calves were assigned equally based on their dietary treatment to one of two pens in earthen open lots for the additional 34 day observation period, where all steers were fed a common diet with no algae meal.

TABLE 3
Diet ingredients and calculated nutrient composition
of the receiving and step-up diets in Example 4.

| | | | | |
|---|---|---|---|---|
| Item | Receiving | Step-up 1 | Step-up 2 | Final |

Ingredient, % DM basis

| | | | | |
|---|---|---|---|---|
| WCGF | 65 | 70 | 75 | 80 |
| Chopped bromegrass hay | 30 | 25 | 20 | 15 |
| Corn dried distillers | 2.86 | 2.86 | 2.86 | 2.86 |
| grains with solubles | | | | |
| Trace mineral premix | 0.024 | 0.024 | 0.024 | 0.024 |
| Calcium carbonate | 1.7 | 1.7 | 1.7 | 1.7 |
| Vitamin A premix | 0.10 | 0.10 | 0.10 | 0.10 |
| Salt | 0.31 | 0.31 | 0.31 | 0.31 |
| Rumensin ®90 | 0.007 | 0.007 | 0.007 | 0.007 |

Nutrient composition (calculated)

| | | | | |
|---|---|---|---|---|
| Dry matter, % | 49.3 | 47.7 | 46.2 | 44.9 |
| Crude protein,% | 16.9 | 17.2 | 17.5 | 17.8 |
| Ether extract, % | 2.1 | 2.1 | 2.1 | 2.1 |
| NDF, % | 49.7 | 48.7 | 47.8 | 46.8 |
| ADF, % | 23.7 | 21.5 | 19.3 | 17.1 |

Trace mineral premix provided per kilogram of diet: 30 mg Zn as ZnSO4, 20 mg Mn as MnSO4, 10 mg Cu as CuSO4, 0.5 mg I as C2H10I2N2, 0.1 mg Se as Na2SeO3, and 0.1 mg Co as CoCO3.
Vitamin A premix contained 4,400,000 IU/kg.
Rumensin ®90: Provided 200 mg−1 • steer−1 • day of the ionophore monensin (Elanco Animal Health, Greenfield, IN).

TABLE 4
Diet ingredients and calculated nutrient composition
of the starter calf dietary treatments in Example 4.

| | | | | |
|---|---|---|---|---|
| Item | ALG0 | ALG15 | ALG30 | ALG45 |

Ingredient, % DM basis

| | | | | |
|---|---|---|---|---|
| WCGF | 80 | 65 | 50 | 35 |
| Algae meal | 0 | 15 | 30 | 45 |
| Bromegrass hay | 15 | 15 | 15 | 15 |
| Corn dried distillers | 2.63 | 2.63 | 2.63 | 2.63 |
| grains with solubles | | | | |
| Trace mineral premix | 0.024 | 0.024 | 0.024 | 0.024 |
| Calcium carbonate | 1.62 | 1.62 | 1.62 | 1.62 |
| Magnesium sulfate | 0.31 | 0.31 | 0.31 | 0.31 |
| Vitamin A premix | 0.10 | 0.10 | 0.10 | 0.10 |
| Salt | 0.31 | 0.31 | 0.31 | 0.31 |
| Rumensin ®90 | 0.014 | 0.014 | 0.014 | 0.014 |

Nutrient composition (calculated)

| | | | | |
|---|---|---|---|---|
| Dry matter, % | 44.9 | 49.9 | 56.1 | 64.1 |
| Crude protein,% | 17.7 | 16.4 | 15.0 | 13.6 |
| Ether extract, % | 2.1 | 2.8 | 3.6 | 4.3 |
| Neutral detergent fiber,% | 46.7 | 45.0 | 43.3 | 41.6 |
| Acid detergent fiber, % | 17.1 | 15.5 | 13.9 | 12.3 |

ALG0: the control diet with no algae meal, A15: 15% inclusion of the algae meal as a direct replacement of WCGF on a DM basis, A30: 30% inclusion of the algae meal, and A45: 45% inclusion of the algae meal.
Trace mineral premix provided per kilogram of diet: 30 mg Zn as ZnSO4, 20 mg Mn as MnSO4, 10 mg Cu as CuSO4, 0.5 mg I as C2H10I2N2, 0.1 mg Se as Na2SeO3, and 0.1 mg Co as CoCO3.
Vitamin A premix contained 4,400,000 IU/kg.
Rumensin ®90: Provided 200 mg−1 • steer−1 • day of the ionophore monensin (Elanco Animal Health, Greenfield, IN).

### Statistical Analysis

### Example 1

In vitro digestion data of the algae meal, bromegrass hay, and soyhulls were analyzed by ANOVA using the MIXED procedure of SAS (SAS Inst. Inc., Cary, N.C.). The model included the fixed effects of feed, hour, and the interaction. Incubation jar served as the random variable.

### Example 2

Statistical analysis of the preference DMI and percent offered data was accomplished using the GLIMMIX procedure of SAS. The model included the fixed effects of diet and pair×diet. Steer, period, day, and steer and period nested within location (left or right side of the bunk) were random effects. The SLICEDIFF statement was utilized to determine the simple effects of both pair and diet. The Tukey adjustment was used to adjust for multiple comparisons for the P-values and confidence limits for the differences of the LSMEANS. Hourly DMI was analyzed using the MIXED procedure of SAS. The model included the fixed effects of diet×hour and pair×diet. Steer, period, day, and steer and period nested within location were random effects. Hour served as the repeated effect and steer was the experimental unit. The covariance structure utilized was autoregressive 1.

### Example 3

Statistical analysis of the rumen feedstuff digestibility, rumen pH, DMI, and rate of digestion data were conducted using the MIXED procedure of SAS. Rumen digestibility data were analyzed as repeated measures and included the fixed effects of experimental diet, hour, and the interaction. Hour served as the repeated effect and steer was the experimental unit. Steer and period were included as random effects in the model. The covariance structure utilized was spatial exponential for hour. The model for analysis of DMI, rumen pH, and rate of digestibility data included the fixed effect of dietary treatment. Steer and period were included as random variables.

### Example 4

The MIXED procedure of SAS was used for the statistical analysis of BW, average daily gain (ADG), and feed efficiency (G:F, gain:feed). The model included the fixed effect of dietary treatment. Steer served as the random variable. Average daily DMI was calculated by week and analyzed using the MIXED procedure of SAS. The model included the fixed effects of dietary treatment, week, and the interaction. Steer served as the random variable. Repeated measures with the covariance structure of autoregressive 1 were used to analyze the repeated effect of week. The subject for the repeated measures analysis was steer*dietary treatment*week.

In Examples 2 and 3, three single-degree-of-freedom contrast statements were utilized: 1) linear effect of algae meal inclusion, 2) quadratic effect of algae meal inclusion, and 3) CON vs. all diets containing algae meal. In Example 4, three single-degree-of-freedom contrast statements were used to determine dietary treatment differences: 1) linear effect of algae meal inclusion, 2) quadratic effect of algae meal inclusion, and 3) cubic effect of algae meal inclusion. For all Examples, significance was declared at P≦0.05 and tendencies at P≦0.10.

### Example 1

### Analysis

The in vitro digestibility of hay was lesser (P<0.001; Table 5) at both 24 and 48 h compared with both the algae meal and soyhulls. The digestibility of the algae meal was greater (P<0.001) at 24 h compared with soyhulls, and there was no difference (P=0.82) between algae meal and soyhulls at 48 h. For each feedstuff, digestibility at 48 h was greater (P<0.001) than at 24 h. Typically, feedstuffs would not be retained in the rumen beyond 20-30 hours in a feedlot situation, thus the 24 hour digestibility represents the value of most interest from this study.

TABLE 5
In vitro dry matter digestibility of feedstuffs (Example 1).

Hour

| Feedstuff, % disappearance | 24 | 48 | SEM | P-value |
|---|---|---|---|---|
| Algae meal | 58.7^{a} | 64.8^{a} | 0.80 | <0.001 |
| Soyhulls | 52.9^{b} | 65.0^{a} | | |
| Bromegrass hay | 30.2^{c} | 42.0^{b} | | |

¹P-value for the interaction of feedstuff × hour of incubation.
^{a-c}Values lacking common superscripts within a column differ.

In this example, the algae meal in vitro digestibility was very similar to soyhulls. We utilized hay in this example as a common fiber source in concentrate-based diets. The low in vitro digestibility results of the hay were expected due to the concentrate-based diet the steers were consuming when the rumen fluid was collected, which would have limited the fiber digesting bacteria within the rumen microbial population. The results of Ex. 1 indicate that algae meal is well digested under simulated rumen conditions.

### Example 2

### Analysis

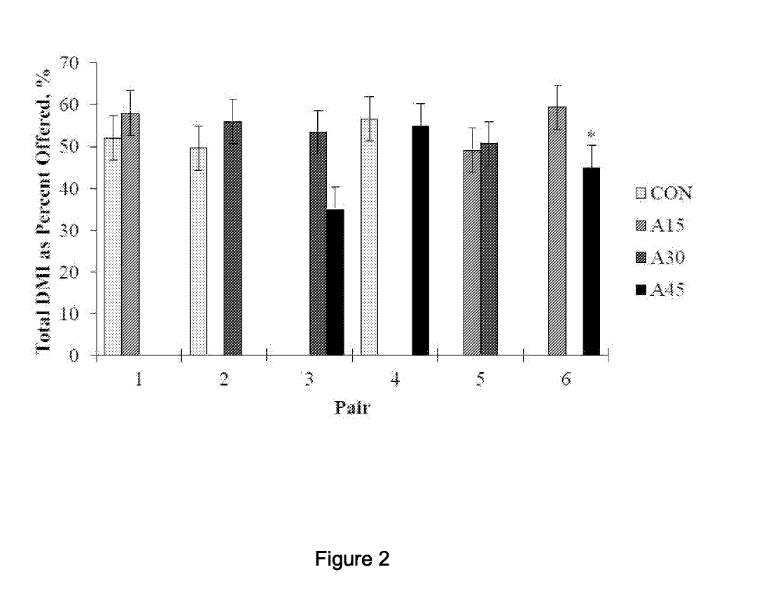

When expressed as a percentage of total DM offered to steers during the 4 hour observation period total DM consumed was affected (P=0.01; FIG. 2) by the paired diet combination. The percent of total DM consumed by steers fed ALG45 was lesser (P≦0.008) when offered in combination with the ALG15 or ALG30 diets, but intake of ALG45 was not different when offered in pair with the CON diet (P=0.76). No other paired diet combinations altered (P≧0.23) the dietary preference of the steers.

There was a pair×diet effect (P=0.03) for the total amount of offered feed consumed. The total kilograms of DM offered of A45 was less (P≦0.01) when in combination with A15 and A30, indicating when given the choice, steers preferred the A15 or A30 diets. There was also a tendency (P=0.08) for the total kilograms of DM of A30 offered was less when in combination with A15. These data indicate that although less total kilograms of A45 was offered, this did not result in an increase in the percentage of total DM consumed when steers were fed that diet. Therefore, whether expressed on total kilograms of DM offered or as a percentage of total DM offered, there was reduced intake of the A45 diet when in combination with A15 or A30.

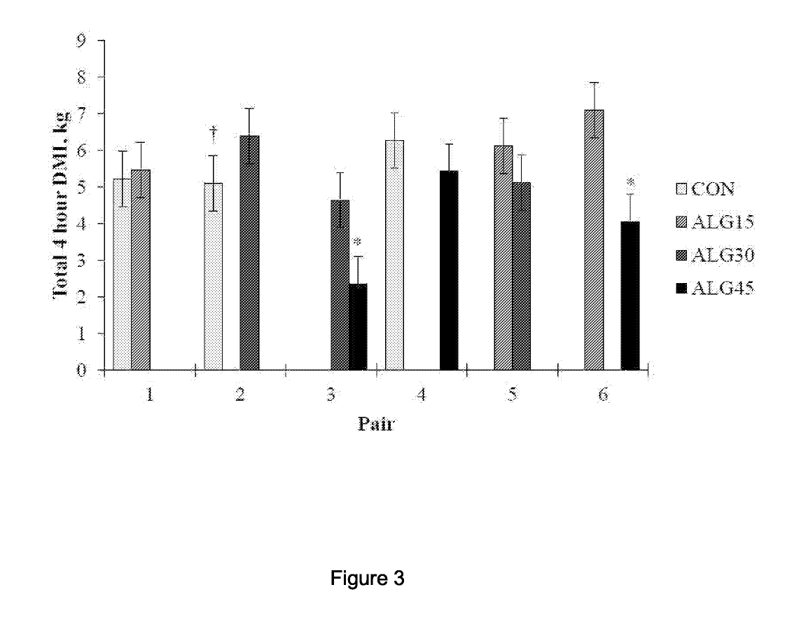

When comparing total 4 hour DMI, similar results were observed. Total 4 hour DMI was decreased (P≦0.004; FIG. 3) in steers consuming the ALG45 diet, but only when offered in combination with the ALG15 or ALG30 diets. There was a tendency (P=0.09) for a decrease in 4 hour DMI in steers consuming ALG30 when offered in combination with CON.

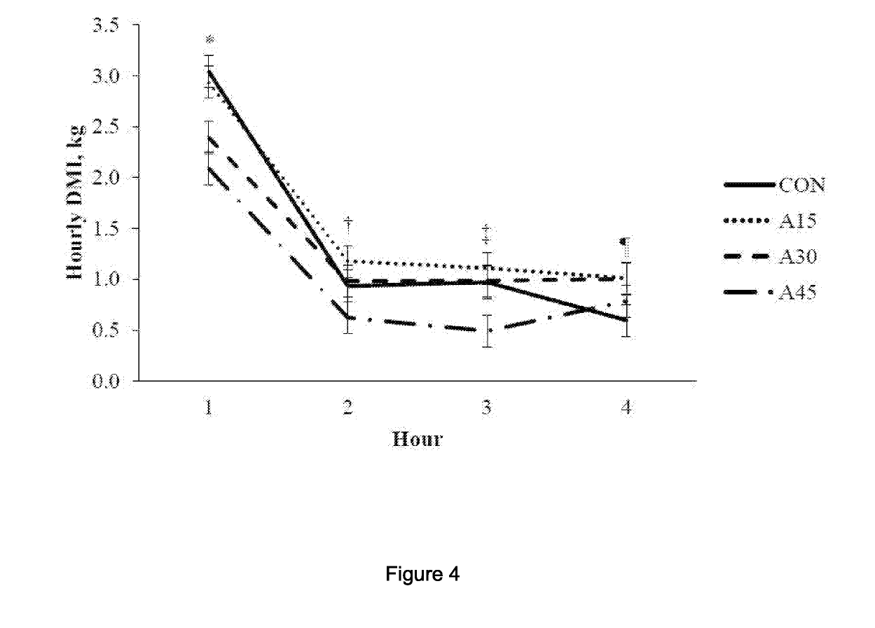

There was a DMI diet×hour effect (P<0.001; FIG. 4) during the 4 hour observation period. During the first hour of feed availability there was greater (P≦0.02) consumption of CON and A15 compared with A30 and A45. During the second hour of observation, there was greater (P=0.01) DMI of A15 than A45, with no differences (P≧0.11) between other paired diet combinations. In hour 3, steers had lesser (P≦0.03) DMI of A45 compared with all other dietary treatments. There were tendencies for CON to have lesser (P≦0.06) DMI compared with A15 or A30 during the fourth observation hour, with A45 being intermediate (P≧0.31).

This experiment was designed to determine if steers would readily consume a diet containing up to 45% algae meal. Steers did not refuse any of the diets, though they seemed to prefer to consume diets other than the A45 diet, perhaps because of the dryness of the A45 diet. Steers readily consumed diets containing up to 30% algae meal, and while they did not refuse to eat the diet containing 45% algae meal, they often preferred the other diets, and consumed this diet more slowly. Dry matter content of the diets increased well over 90% as more algae meal was added to the diet. It is well understood that moisture content of the total diet can influence DMI of cattle, thus the limited moisture content of the diets containing more algae meal may help explain the decrease in preference for the A45 diet. Dry diets also allow steers to sort smaller feed particles out from the rest of the diet. In trials assessing the effect of algae meal on ruminant performance in the future, sufficient diet moisture will be an important consideration.

### Example 3

### Analysis

To determine DM digestibility of the feeds in the rumen an in situ procedure was utilized. Numerous in situ digestion procedures have been utilized to determine DM digestibility previously (Stern, M.D., A. Bach, and S. Calsamiglia. 1997; Alternative techniques for measuring nutrient digestion in ruminants; J. Anim. Sci. 75:2256-2276; Olaisen, V., T. Mejdell, H. Volden, and N. Nesse. 2003. Simplified in situ method for estimating dry matter and protein degradability of concentrates. J. Anim. Sci. 81:520-528; Gargallo, S., S. Calsamiglia, an A. Ferret. 2006. Technical note: A modified three-step in vitro procedure to determine intestinal digestion of proteins. J. Anim. Sci. 84:2163-2167).

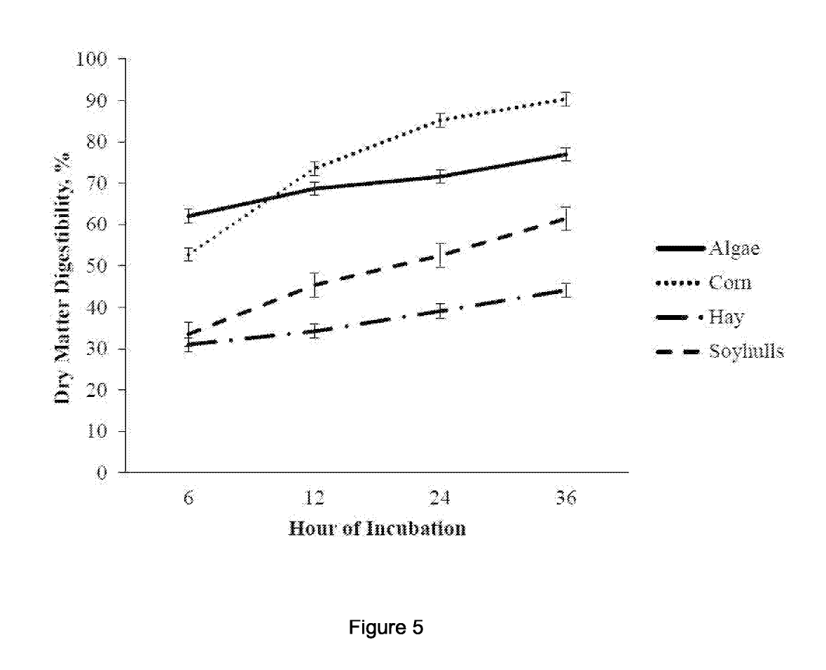

Dietary composition directly impacts rumen microbial populations and thus it is best to measure rumen digestibility of a feedstuff in the rumen of a steer consuming at least some amount of the feedstuff in the diet. Because we fed the 4 concentrations of algae meal in this experiment (0, 15, 30 or 45% algae meal, DM basis), we took the opportunity to assess DMI of the steers during each period. Although steers were limited at 2% of their BW on a DM basis, all steers did not consume the full amount fed, regardless of diet. There was a linear decrease (P=0.05; Table 6) in DMI as the algae meal increased in the diet. There also tended (P=0.09) to be greater DMI of the CON diet by steers compared with diets containing algae meal. There was no effect (P≧0.17) of diet on rumen pH measured at 6 h post-feeding on day 14 of each period. There was no effect of diet (P≧0.36; Table 6) or diet×hour (P≧0.40) on the rumen digestibility of the algae meal, corn, hay, or soy hulls. There was an effect for hour (P<0.001; FIG. 5), where overall the DM digestibility of the algae meal was lesser than corn, but greater than soyhulls (FIG. 5). For the algae meal (P=0.06) and corn (P=0.09), the inclusion of algae tended to improve the rate of digestion. There was no effect (P≧0.11) of experimental diet on the rate of digestion of bromegrass hay or soyhulls.

Similar to the in vitro example, the bromegrass hay was the least digestible due to the fiber content and the lesser population of fiber digesting bacteria present in the rumen of concentrate-fed steers. Both the algae meal and corn were rapidly digested in the first 6 hours of in situ incubation. Based on these results corn was the most digestible, followed by algae meal, soyhulls, and hay. The digestibility of the algae meal is intermediate to that of corn and soyhulls, indicating it has no discernibly negative impacts on rumen microbial populations, and in fact can be a replacement for corn or soyhulls in cattle diets.

TABLE 6
The effects of dietary algae meal inclusion on rumen pH, DMI, and rumen
digestibility (Ex. 3).

| Dietary treatment | | | | | Contrasts | | | |
|---|---|---|---|---|---|---|---|---|
| Item | CON | A15 | A30 | A45 | SEM | Linear | Quadratic | No Alg vs. Alg |
| Rumen pH | 5.72 | 5.68 | 5.65 | 5.53 | 0.125 | 0.17 | 0.64 | 0.33 |
| DMI, kg/d | 20.3 | 19.6 | 19.2 | 18.2 | 0.75 | 0.05 | 0.80 | 0.09 |

Rate of digestion, % DM digested/h

| | | | | | | | | |
|---|---|---|---|---|---|---|---|---|
| Algae meal | 2.04 | 2.20 | 2.10 | 2.21 | 0.080 | 0.09 | 0.59 | 0.06 |
| Corn | 2.48 | 2.51 | 2.52 | 2.53 | 0.015 | 0.09 | 0.55 | 0.09 |
| Soyhulls | 1.60 | 1.84 | 1.62 | 1.77 | 0.148 | 0.31 | 0.51 | 0.11 |
| Bromegrass | 1.19 | 1.31 | 1.15 | 1.26 | 0.076 | 0.69 | 0.86 | 0.19 |
| hay | | | | | | | | |

Dietary treatment: CON: the control diet with no algae meal, A15: 15% inclusion of the algae meal as a direct replacement of corn on a DM basis, A30: 30% inclusion of the algae meal, and A45: 45% inclusion of the algae meal.
Single-degree-of-freedom contrasts: 1) linear dietary inclusion of the algae meal, 2) quadratic dietary inclusion of the algae meal, and 3) CON vs. all algae meal containing diets.
Daily DMI was averaged for each period and analyzed and LSMEANS are presented for the overall experiment.
Rate of digestibility represents the percent of DM digested per hour for the 36 hour digestion experiment.

### Example 4

### Analysis

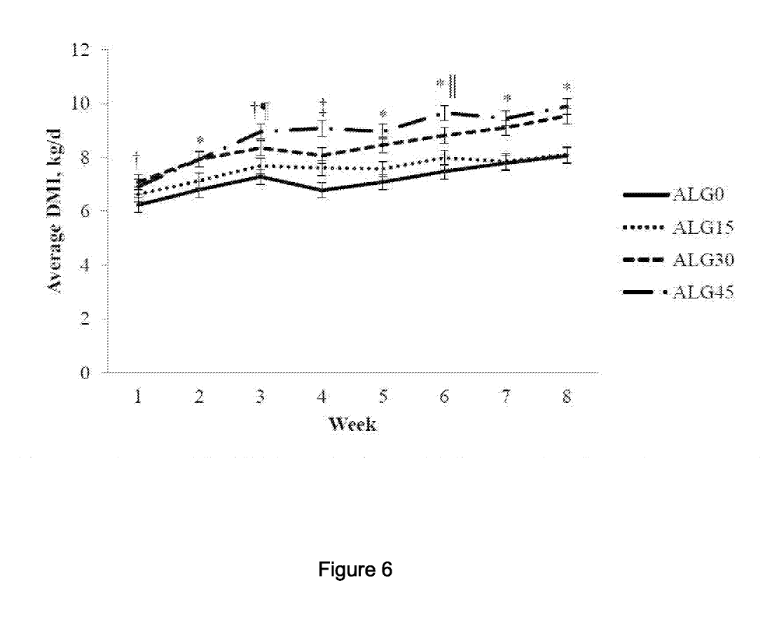

Midpoint and final BW of steers was not affected (P≧0.42; Table 7) by the inclusion of algae meal in the diet. There was a dietary treatment×week effect (P=0.005; FIG. 6) for steer DMI. In weeks 1 and 3, average DMI was decreased (P≦0.04) in the ALGO steers compared with the ALG30 steers. In weeks 2, 5, 6, 7, and 8, the ALGO and ALG15 steers had lesser (P≦0.05) DMI compared with the ALG30 and ALG45 steers. In week 3, the ALG45 steers had greater (P≦0.002) DMI than the ALGO and ALG15 steers. In week 4, the ALGO steers had lesser (P≦0.04) DMI than all other dietary treatments. Also in week 4, ALG15 and ALG30 were not different (P=0.25), but were lesser (P≦0.01) than ALG45. The ALG45 steers had greater (P=0.04) DMI than the ALG30 steers in week 6. During the 56 day trial, there was a linear increase in DMI (P<0.001) as the algae meal increased in the diet. During the first 27 days of the trial, there was a cubic (P=0.01) response for ADG, where ALG15 and ALG45 steers had greater ADG than ALGO and ALG30 steers. During the final 29 days of the project, there tended to be a quadratic (P=0.09) response, with ALG15 tending to have lesser ADG compared with all other dietary treatments. Over the entire 56 day trial, steer ADG tended (P=0.06) to linearly increase as algae meal increased in the diet. During the first 27 days of the trial, there was a cubic (P=0.01) response, where ALG15 had the greatest G:F, ALG30 had the least, and ALGO and ALG45 were intermediate. During the last 29 days of the trial, there was a linear (P=0.04) decrease in G:F as algae meal was increased in the diet. Feed efficiency of the steers during the 56 day trial was very good overall, and was linearly decreased (P=0.01) as algae meal increased in the diet.

Contrary to Examples 2 and 3, steers consuming the diet with 45% algae meal had increased DMI relative to the other treatments. The increased DMI of the ALG45 steers also improved ADG, but decreased feed efficiency. The linear effect of algae meal on steer DMI indicates that steers will readily consume a diet with up to 45% algae meal included in a WCGF-based diet. Because it is critical for newly received steers to have good feed intake it is very interesting to note the linear improvement in DMI as algae meal inclusion increased in the diet. This does not appear to be a moisture effect, and could mean that algae meal would be very useful in starter calf diets for feedlots.

TABLE 7
Effects of increasing dietary algae meal on starter steer performance (Ex. 4).

| Dietary treatment | | | | | Contrasts | | | |
|---|---|---|---|---|---|---|---|---|
| Item | ALG0 | ALG15 | ALG30 | ALG45 | SEM | Linear | Quadratic | Cubic |

BW, kg

| | | | | | | | | |
|---|---|---|---|---|---|---|---|---|
| Day 1 | 292 | 292 | 296 | 290 | 6.7 | 0.93 | 0.66 | 0.66 |
| Day 27 | 336 | 343 | 340 | 340 | 6.6 | 0.72 | 0.61 | 0.67 |
| Day 56 | 384 | 385 | 390 | 391 | 6.8 | 0.42 | 0.95 | 0.76 |

DMI, kg/d

| | | | | | | | | |
|---|---|---|---|---|---|---|---|---|
| Day 1 to 27 | 6.76 | 7.24 | 7.84 | 8.20 | 0.228 | <0.001 | 0.78 | 0.72 |
| Day 28 to 56 | 7.58 | 7.87 | 8.95 | 9.46 | 0.236 | <0.001 | 0.65 | 0.20 |
| Day 1 to 56 | 7.19 | 7.57 | 8.42 | 8.85 | 0.217 | <0.001 | 0.91 | 0.37 |

ADG, kg/d

| | | | | | | | | |
|---|---|---|---|---|---|---|---|---|
| Day 1 to 27 | 1.62 | 1.88 | 1.65 | 1.87 | 0.082 | 0.18 | 0.83 | 0.01 |
| Day 28 to 56 | 1.67 | 1.44 | 1.71 | 1.75 | 0.078 | 0.17 | 0.09 | 0.35 |
| Day 1 to 56 | 1.65 | 1.65 | 1.68 | 1.81 | 0.058 | 0.06 | 0.31 | 0.79 |

G:F

| | | | | | | | | |
|---|---|---|---|---|---|---|---|---|
| Day 1 to 27 | 0.244 | 0.262 | 0.209 | 0.229 | 0.0119 | 0.07 | 0.94 | 0.01 |
| Day 28 to 56 | 0.223 | 0.182 | 0.192 | 0.187 | 0.0103 | 0.04 | 0.10 | 0.16 |
| Day 1 to 56 | 0.233 | 0.219 | 0.200 | 0.206 | 0.0088 | 0.01 | 0.29 | 0.42 |

Dietary treatment: ALG0: the control diet with no algae meal, A15: 15% inclusion of the algae meal as a direct replacement of WCGF on a DM basis, A30: 30% inclusion of the algae meal, and A45: 45% inclusion of the algae meal.
Three single-degree-of-freedom contrast statements were used to determine dietary treatment differences: 1) linear effect of algae meal inclusion, 2) quadratic effect of algae meal inclusion, and 3) cubic effect of algae meal inclusion.
Feed efficiency: kg of weight gain per kg of DM.

Overall, these studies indicate that algae meal is highly digestible in concentrate-based diets for use as an alternative feedstuff in beef feedlot diets. The digestibility studies show that algae meal is readily digested within the rumen and is intermediate in digestibility between corn and soyhulls. The digestibility data also indicate that algae meal can replace a portion of high energy feedstuff in a diet, such as corn. The clear differences in intake of diets containing 45% algae meal between Examples 2-3 and 4 suggest that the very dry nature of the algae meal product may be a limitation to dietary inclusion, if moisture is not added to the diet from other ingredients such as wet corn gluten feed, wet distillers grains, modified distillers grains, or other ingredients. The most common source of protein (and some energy) in Midwestern feedlot diets is modified or wet distillers grains, so most diets will have some moisture from these ingredients. Additionally, these data indicate that algae meal makes an excellent feed ingredient in starter cattle diets, as feed intake was increased when greater amounts of algae meal were included in the diet.

### Example 5

### Lamb Study

Ten whiteface cross wethers (74.32±1.22 lbs) were used in a replicated 5×5 Latin square to determine the diet dry matter (DM) nutrient digestibility and nitrogen retention of sheep fed one of 5 diets (n=2 lambs per treatment per period) containing varying concentrations of algae meal (ALG). A Latin square design allows animals to receive all diets throughout the trial, accounting for differences in individual animal digestibility. Treatments included one of 5 diets (Table 8): a corn-based control (CON), 15% algae meal (15% ALG), 30% algae meal (30% ALG), 45% algae meal (45% ALG), and 60% algae meal (60% ALG). Algae meal was added at the expense of dry rolled corn in all diets and diets included 25% wet corn gluten feed (WCGF) to meet the crude protein (CP) requirements of the sheep and to add moisture to the diet. Diets were mixed 3 times per week for a minimum of 5 minutes in a commercial grade cement mixer (Kobalt Model SGY-CM1; 0.11 m3; 1626 rpm).

TABLE 8
Ingredient composition of lamb digestibility diets (% DM basis).

| | Treatment | | | | |
|---|---|---|---|---|---|
| Ingredient, | | 15% | 30% | 45% | 60% |
| % DM | Control | Algae | Algae | Algae | Algae |
| Corn | 60.00 | 45.00 | 30.00 | 15.00 | — |
| Wet corn gluten feed | 25.00 | 25.00 | 25.00 | 25.00 | 25.00 |
| Hay | 10.00 | 10.00 | 10.00 | 10.00 | 10.00 |
| Algae meal | — | 15.00 | 30.00 | 45.00 | 60.00 |
| Corn dried distillers | 1.44 | 1.44 | 1.44 | 1.44 | 1.44 |
| grains¹ | | | | | |
| Limestone | 2.10 | 2.10 | 2.10 | 2.10 | 2.10 |
| Salt | 0.31 | 0.31 | 0.31 | 0.31 | 0.31 |
| Ammonium chloride | 0.50 | 0.50 | 0.50 | 0.50 | 0.50 |
| Lasalocid² | 0.015 | 0.015 | 0.015 | 0.015 | 0.015 |
| Vitamin A, D, and E | 0.10 | 0.10 | 0.10 | 0.10 | 0.10 |
| premix³ | | | | | |
| Trace mineral premix⁴ | 0.54 | 0.54 | 0.54 | 0.54 | 0.54 |

¹Carrier for micro-ingredients.
²Provided Lasalocid at 25 g/909 kg of diet DM.
³Contained 900,000 IU of Vitamin A, 225,000 IU of Vitamin D, and 180 IU of Vitamin E per kg of premix.
⁴Provided per kilogram of diet DM: 500 mg of Mg (magnesium sulfate), 30 mg of Zn (zinc sulfate), 25 mg of Mn (manganese sulfate), 0.6 mg of I (calcium iodate), 0.22 mg Se (sodium selenite), and 0.2 mg of Co (cobalt carbonate).

TABLE 9
Analyzed nutrient composition of diets.

| | | | | | | | P-value | | | |
|---|---|---|---|---|---|---|---|---|---|---|
| | Algae meal | | | | | | CON v | | | |
| | CON¹ | 15% | 30% | 45% | 60% | SEM | Algae | Linear | Quadratic | Cubic |
| Dry | 66.28 | 68.38 | 70.62 | 71.73 | 72.59 | 0.383 | <0.001 | <0.001 | 0.02 | 0.75 |
| matter | | | | | | | | | | |

%, DM basis

| | | | | | | | | | | |
|---|---|---|---|---|---|---|---|---|---|---|
| NDF | 25.20 | 29.73 | 33.01 | 35.13 | 40.20 | 1.195 | <0.001 | <0.001 | 0.99 | 0.28 |
| ADF | 9.66 | 13.09 | 16.05 | 18.29 | 22.09 | 0.714 | <0.001 | <0.001 | 0.99 | 0.38 |
| Ether | 2.89 | 3.29 | 3.91 | 4.38 | 4.76 | 0.169 | <0.001 | <0.001 | 0.77 | 0.56 |
| extract | | | | | | | | | | |
| Nitrogen | 1.76 | 1.81 | 1.75 | 1.80 | 1.79 | 0.029 | 0.33 | 0.54 | 0.79 | 0.62 |
| Crude | 10.98 | 11.30 | 10.96 | 11.25 | 11.18 | 0.180 | 0.33 | 0.54 | 0.79 | 0.62 |
| protein | | | | | | | | | | |

¹Corn based control diet.

Prior to the start of the trial, lambs were transported to the metabolism facilities and fed a concentrate-based diet for 5 days. Prior to the initiation of the trial, all lambs were consuming a concentrate-based diet. Experimental periods lasted 15 days with 10 days for adaptation to treatment diets and 5 days for total fecal and urine collection. For the first 3 days of adaptation, lambs were paired by treatment and housed in pens. On day 4, lambs were moved to individual metabolism crates to allow for total collection of urine and feces. Lambs were allowed ad libitum access to water and were fed the total mixed ration (TMR) at 0800 h daily. The amount of feed offered during adaptation was near ad libitum intake, as determined for each individual lamb daily. During the collection period, feed was offered at 105% of the average intake for the previous five days, which resulted in most lambs having feed refusals each morning.

A clean urine collection vessel containing 200 mL of 6 N acetic acid, to maintain a urine pH below 3, was placed under each lamb at 0700 h for daily collection of urine from day 10 through day 15 of each period. Feces was also collected from day 10 through day 15 in pans located under the lambs as part of the metabolism crate. These pans were lined with tared plastic bags and bags were replaced at 0700 h for daily fecal collection. Blood (approximately 10 mL) was collected via jugular venipuncture into heparinized (158 USP units of sodium heparin) vacutainer tubes (Becton, Dickinson and Company, Franklin Lakes, N.J.) 4 h after feeding (1200 h) on day 10 through day 15. Blood samples were immediately placed on ice for transportation to the laboratory and centrifuged (1,200×g, 4 C, 12 min) within 1 h of collection. Plasma was extracted and frozen at −80° C. for later analysis of plasma urea-N (PUN). Plasma urea-N was determined with a commercially available colorimetric assay (Procedure No. 2050, Stanbio Laboratory, Boerne, Tex.) using a spectrophotometer (Eon Microplate Spectrophotometer, BioTek, Winooski, Vt.) at a wavelength of 600 nm.

Samples of each treatment TMR (50 g/d) were collected at 0900 h during day 10 through day 15, pooled, and dried in a 70° C. forced air oven for 48 h and weighed to determine partial DM. If feed refusals (orts) were present they were removed at 0700 h daily, weighed, and a maximum of 200 g subsample was taken. This subsample was then dried in a 60° C. convection oven for 96 h and weighed to determine partial DM. Collection vessels for urine were removed at 0700 h daily and pH was tested and total weight and volume was recorded for each individual lamb. Urine samples were thoroughly mixed and 10% of the daily output by weight was sampled, added to the composite sample for that period, and frozen (−20° C.). Plastic bags containing feces were removed from crates at 0700 h daily and weighed. Fecal samples were thoroughly mixed by hand and a 10% subsample was collected. Feces were then placed in a 60° C. convection oven for 96 h and weighed to determine partial DM.

Once samples were dried, TMR and orts were ground to pass through a 2 mm screen (Thomas-Wiley Laboratory Mill Model 4, Thomas Scientific USA, Swedesboro, N.J.) and fecal samples were ground to pass through a 2 mm screen in a Retsch ZM 100 grinding mill (Retsch GMbH, Haan, Germany). Fecal and orts samples were then composited by sheep within period on an equal dried weight basis. The true DM of TMR, orts, and fecal samples was determined by drying subsamples for 24 h at 105° C. in a forced-air oven according to AOAC (1999) procedures. Organic matter (OM) was determined by ashing in a muffle furnace (Isotemp Muffle Furnace, Model 186, Fisher Scientific, Montreal, Quebec, Canada) for 4 h at 600° C. according to AOAC (1999) procedures. Neutral detergent fiber (NDF) and acid detergent fiber (ADF) were determined using sequential analysis utilizing an ANKOM200 Fiber Analyzer (ANKOM Technology, Macedon, N.Y.) with the addition of alpha-amylase using the methods of Van Soest et al. (1991). Urine was pooled by sheep within period. A subsample of urine, fecal, orts, and feed was sent to the University of Arkansas Central Analytical Laboratory (Poultry Science Center, Fayetteville, Ark.) for nitrogen and ether extract analysis.

Digestibility of all nutrients was calculated based on true DM for each period. Digestibility was calculated as a percent by subtracting the total output from the total intake, dividing by total intake, and multiplying the value by 100. Total intake is defined by the total feed offered minus the orts. Total output is defined as the total fecal output. Nitrogen balance was calculated by subtracting the N excreted (amount of N in the feces and urine) from the N intake (total N in feed minus total N in orts). Nitrogen balance is reported as the average daily retention in grams per day. Crude protein (CP) was calculated as N×6.25.

### Example 5

### Statistical Analysis

### Example 5

Data were analyzed by ANOVA using the Mixed procedure of SAS (SAS Institute, Inc., Cary, N.C.). Individual lambs served as the experimental unit for all analysis (n=10). Period, dietary treatment, and lamb within square were considered fixed effects for digestibility, input, and output analysis and period and dietary treatment were considered fixed effects for dietary analysis. All data were examined for outliers using Cook's D and 1 outlier was removed from the NDF and ADF digestibility dataset prior to further analysis. Four single degree of freedom contrast statements were constructed prior to analysis: 1) CON vs. ALG, 2) linear, 3) quadratic, and 4) cubic effects of increasing inclusion of ALG (0, 15, 30, and 45% DM of ALG). Significance was declared at P≦0.05 and tendencies were declared at 0.06≦P≦0.10. Means reported in the tables are least squares means.

### Example 5

### Analysis

The analyzed composition of the experimental diets is reported in Table 9. Dry matter was lesser (P<0.001) for CON than ALG. There were linear (P<0.001) and quadratic (P=0.02) effects of ALG inclusion on diet DM. Neutral detergent fiber, ADF, and ether extract concentrations were lesser (P<0.001) for CON than ALG, and there was a linear (P<0.001) increase in these nutrients as inclusion of ALG increased in the diet. Nitrogen, and thus CP, did not differ across diets (P=0.33).

TABLE 10
Lamb intake and output calculations (% DM basis).

| | | | | | | | P-value | | | |
|---|---|---|---|---|---|---|---|---|---|---|
| | | Algae meal | | | | | CON v | | | |
| | CON¹ | 15% | 30% | 45% | 60% | SEM | Algae | Linear | Quadratic | Cubic |
| Lambs (n) | 10 | 10 | 10 | 10 | 10 | | | | | |
| DMI, | 2.23 | 2.54 | 2.85 | 2.62 | 2.75 | 0.598 | 0.01 | 0.01 | 0.09 | 0.43 |
| lbs/d | | | | | | | | | | |
| OMI, | 2.20 | 2.41 | 2.70 | 2.45 | 2.55 | 0.562 | 0.01 | 0.04 | 0.09 | 0.46 |
| lbs/d | | | | | | | | | | |
| Daily output | | | | | | | | | | |
| Fecal, lbs | 0.57 | 0.68 | 0.86 | 0.85 | 0.90 | 0.220 | <0.001 | <0.001 | 0.06 | 0.90 |
| of DM/d | | | | | | | | | | |
| Fecal, lbs | 0.52 | 0.62 | 0.79 | 0.78 | 0.82 | 0.203 | <0.001 | <0.001 | 0.07 | 0.86 |
| of OM/d | | | | | | | | | | |
| Urine, | 1.93 | 1.96 | 1.65 | 2.05 | 2.51 | 0.215 | 0.66 | 0.08 | 0.06 | 0.56 |
| L/d | | | | | | | | | | |

¹Corn based control diet.

Dry matter intake and OM intake (OMI) and fecal and urine outputs are reported in Table 10. During the 5 day collection period, lamb DMI and OMI were lesser (P=0.01) for CON than ALG, and there was both a linear (P≦0.04) increase and a tendency for a quadratic (P=0.09) effect of ALG inclusion. This is likely explained by the lesser DMI and OMI of lambs on the CON diet while lambs consuming ALG at any concentration had similar DMI and OMI. Correspondingly, daily fecal DM and OM output were lesser (P<0.001) for CON than ALG with both linear (P≦0.001) increases and a tendency for a quadratic (P≦0.07) increase in fecal DM and OM output as ALG increased in the diet. Urine output was not different (P=0.66) between CON and ALG; however, there was a tendency for both a linear (P=0.08) and quadratic (P=0.06) effect due to ALG inclusion. These effects appear to be driven by the greater amount of urine produced by the 60% ALG lambs and the lesser amount of urine produced by the 30% ALG lambs.

TABLE 11
Lamb digestibility calculations (% DM basis).

| | | | | | | | P-value | | | |
|---|---|---|---|---|---|---|---|---|---|---|
| | | Algae meal | | | | | CON v | | | |
| | CON | 15% | 30% | 45% | 60% | SEM | Algae | Linear | Quadratic | Cubic |
| Lambs (n) | 10 | 10 | 10 | 10 | 10 | | | | | |
| DM | 75.1 | 73.3 | 69.8 | 68.0 | 67.5 | 0.70 | <0.001 | <0.001 | 0.11 | 0.20 |
| digestibility % | | | | | | | | | | |
| OM | 76.4 | 74.5 | 70.7 | 68.9 | 68.1 | 0.69 | <0.001 | <0.001 | 0.12 | 0.20 |
| digestibility % | | | | | | | | | | |
| NDF | 37.5 | 44.8 | 44.7 | 44.9 | 50.7 | 1.70 | <0.001 | <0.001 | 0.68 | 0.03 |
| digestibility % | | | | | | | | | | |
| ADF | 39.9 | 46.9 | 44.7 | 43.5 | 48.1 | 1.92 | 0.01 | 0.04 | 0.61 | 0.02 |
| digestibility % | | | | | | | | | | |
| Ether | 83.5 | 87.0 | 87.9 | 87.9 | 89.5 | 1.20 | 0.002 | 0.002 | 0.31 | 0.27 |
| extract | | | | | | | | | | |
| digestibility % | | | | | | | | | | |
| N | 68.5 | 7.0 | 61.8 | 59.1 | 59.3 | 0.95 | <0.001 | <0.001 | 0.11 | 0.03 |
| digestibility % | | | | | | | | | | |
| N balance, | 7.53 | 9.25 | 8.87 | 7.20 | 8.99 | 0.754 | 0.22 | 0.72 | 0.69 | 0.03 |
| g/d | | | | | | | | | | |

Diet digestibility data are reported in Table 11. Dry matter digestibility and OM digestibility were greater (P<0.001) for CON than ALG and linearly (P<0.001) decreased as the inclusion of ALG increased. Neutral detergent fiber and ADF digestibility were lesser (P≦0.01) for CON than ALG. There was a linear (P≦0.04) and cubic (P≦0.03) effect of ALG inclusion for NDF and ADF digestibility data. This is due to lesser digestibility by CON and greater digestibility by 60% ALG, while the intermediate ALG inclusions (15, 30, and 45%) were very similar. Ether extract digestibility was lesser (P=0.002) for CON than ALG, and there was a linear (P=0.002) increase in ether extract digestibility due to the lesser digestibility by the CON lambs and the increased digestibility of the 60% ALG lambs. Lambs consuming the CON diet had greater (P<0.001) N digestibility than ALG lambs. There was both a linear (P<0.001) and cubic (P=0.03) effect for N digestibility, likely explained by the lesser, yet similar, N digestibility's of the 30% ALG, 45% ALG, and 60% ALG lambs. There was no difference (P=0.22) in N balance between CON and ALG. However, there was a cubic (P=0.03) effect of ALG inclusion for N balance, which is likely driven by the greater N balance of the 15% ALG lambs and the lesser balance of the 45% ALG lambs.

### Example 6

### Nutrient Digestibility in Finishing Lambs

In the de-oiling process, heterotrophic microalgae is combined with soyhulls and pressed to remove oil to form an algae meal (ALG) which contains partially deoiled microalgae (DMA; 57% DM basis) and soyhulls (43%). Eight whiteface wethers (23.02±0.54 kg) were used in a 4×4 Latin square to determine the impact of the DMA portion of ALG on total tract nutrient digestibility. Lambs received 1 of 4 isonitrogenous dietary treatments (2 sheep·diet⁻¹·period⁻¹) where ALG was added at the expense of soyhulls: a soyhulls-based control (CON), 10% DMA from ALG (DMA10), 20% DMA from ALG (DMA20), and 30% DMA from ALG (DMA30). Soyhulls were sourced from the plant where algae meal was prepared. All diets included 15% wet corn gluten feed (WCGF) on a DM basis to add moisture to the diet. Diets were prepared once per week by mixing for a minimum of 3 minutes in a stainless steel, 0.283 m³ double ribbon blender. Total mixed rations were stored in a walk-in refrigerator (4° C.) in sealed barrels (189.3 L) to prevent spoiling. There were 4 periods, with 10 d of adaptation and 5 d of total fecal and urine collection. Prior to each collection period was a 14 d washout period where all lambs were fed a common diet (Table 12). For the washout period and the first 3 d of adaptation in the experimental period lambs were paired by treatments and housed in pens. Pens were bedded with large flake coarse wood shavings (America's Choice, Columbia, Md.), and bedding was replaced 3 times per week. When lambs were moved to metabolism crates pens were stripped and hosed clean. On d 4 of the experimental period lambs were moved to individual metabolism crates for total collection of feces and urine. Lambs were allowed ad libitum access to water and were fed the total mixed ration (TMR) at 0800 h daily. Waterers were checked and filled twice daily at 0800 and 1700 h. Feed was offered during washout and adaptation periods to attempt to meet ad libitum intake. During the collection period feed was offered at 105% of the average daily intake for the previous 5 days; this resulted in most lambs having feed refusals each morning. On d 1 of the first experimental period and d 1 of the fourth washout period lambs were given a vitamin E injection of 3 mL of Essential E-300 subcutaneously (300 IU Vitamin E per mL, Aspen Veterinary Resources, Liberty, Mo.). At the end of the fourth collection period all lambs were moved to pens and began receiving the washout diet. They remained in pens in the metabolism room for 3 d. Lambs were then transported to the Iowa State University sheep teaching farm for another 31 days of withdrawal and observation period.

TABLE 12
Ingredient composition of finishing lamb diets (% DM basis).

| | | Partially Deoiled Microalgae | | | |
|---|---|---|---|---|---|
| Ingredient (% DM) | Control | 10% | 20% | 30% | Washout |
| Corn | 19.26 | 19.90 | 20.54 | 21.19 | 30.36 |
| WCGF¹ | 15 | 15 | 15 | 15 | 15 |
| Hay | 8 | 8 | 8 | 8 | 10 |
| Algae meal² | — | 17.54 | 35.09 | 52.63 | — |
| Ground soyhulls³ | 52.63 | 35.09 | 17.54 | — | 39.12 |
| Corn oil | 2.10 | 1.40 | 0.70 | — | 2.10 |
| Limestone | 0.48 | 0.32 | 0.16 | — | 0.43 |
| Salt | 0.29 | 0.24 | 0.20 | 0.16 | 0.30 |
| Urea⁴ | 0.20 | 0.31 | 0.42 | 0.53 | 0.43 |
| Ammonium chloride | 0.50 | 0.50 | 0.50 | 0.50 | 0.50 |
| Ca carbonate | 0.63 | 0.87 | 1.10 | 1.33 | 0.85 |
| Elemental S | 0.25 | 0.17 | 0.09 | — | 0.25 |
| Bovatec⁵ | 0.02 | 0.02 | 0.02 | 0.02 | 0.02 |
| Vitamin A, D, and | 0.10 | 0.10 | 0.10 | 0.10 | 0.10 |
| E premix⁶ | | | | | |
| Trace mineral | 0.54 | 0.54 | 0.54 | 0.54 | 0.54 |
| premix^{7,8} | | | | | |

¹Wet corn gluten feed
²Contains 43% soyhulls and 57% delipidated algae
³Similar to the soyhulls utilized in the production of algae meal
⁴Contained 46% N
⁵Provided Lasalocid at 25 g/909 kg of diet DM
⁶Contained 900,000 IU of Vitamin A, 225,000 IU of Vitamin D, and 180 IU of Vitamin E per kg of premix
⁷Provided per kilogram of diet DM: 30 mg of Zn (zinc sulfate), 25 mg of Mn (manganese sulfate), 0.6 mg of I (calcium iodate), 0.22 mg of Se (sodium selenite), and 0.2 mg of Co (cobalt carbonate)
⁸Magnesium sulfate added to achieve a concentration of 0.28% in all diets

TABLE 13
Breakdown of corn, soyhulls, and partially deoilded microalgae (DMA) within
lamb experimental diets.

| | Algae | DMA from | Soyhulls from | Added | Total | | |
|---|---|---|---|---|---|---|---|
| Treatment | meal¹ | algae meal, % | algae meal, % | soyhulls, % | soyhulls, % | Corn, % | Hay, % |
| Control | 0 | 0 | 0 | 52.63 | 52.630 | 18.42 | 8.0 |
| 10% DMA | 17.54 | 9.998 | 7.542 | 35.09 | 42.632 | 19.30 | 8.0 |
| 20% DMA | 35.09 | 20.001 | 15.089 | 17.54 | 32.629 | 20.19 | 8.0 |
| 30% DMA | 52.63 | 29.999 | 22.631 | 0 | 22.631 | 21.04 | 8.0 |
| Washout | 0 | 0 | 0 | 39.12 | 39.120 | 30.00 | 10.0 |

¹Algae meal is a combination of the DMA (57%) and soyhulls (43%)

From d 10 through d 15, at 0700 h a clean plastic urine collection tub (26.35×69.22×13.97 cm) containing 200 mL of 6 M acetic acid, was placed under each crate to collect urine over a 24 h period. Acetic acid was added to maintain urine pH below 4 to prevent volatilization of N. Feces were also collected on d 10 through d 15 using pans located under the back of the metabolism crates. Fecal pans were lined with pre-weighed and labeled plastic bags that were replaced at 0700 h for daily fecal collection.

Each TMR was sampled (50 g/d) at 0800 h daily from d 10-15 of the experimental period, pooled within dietary treatment, and then dried in a 70° C. forced air oven for 48 h and weighed to determine partial DM. If feed refusals (orts) were present, they were removed at 0700 h daily and weighed and recorded. A maximum of 200 g was subsampled daily and placed in a 60° C. convection oven for a minimum of 96 h and weighed again to determine partial DM. Urine collection tubs were removed at 0700 h daily, pH was tested and recorded, and total weight and volume of urine for each lamb was recorded. Urine was thoroughly mixed and 10% of the daily output by weight was sampled and added to a composite for that period. Urine composites were frozen (−20° C.) until further analysis. Tared plastic bags containing feces were removed from crates at 0700 h daily, weighed, and the weight recorded. Fecal samples were thoroughly mixed by hand and a 10% subsample was collected. Fecal subsamples were placed in a 60° C. convection oven for a minimum of 96 h and weighed to determine partial DM.

Once feces, orts, and TMRs were dried, they were ground to pass through a 2 mm screen in a Retsch ZM 100 grinding mill (Retsch GMbH, Haan, Germany). The grinding mill was thoroughly cleaned with a brush and vacuum to remove any residue between samples. Fecal and ort samples were composited by sheep within each collection period on an equal dried weight basis. Sample analyses were conducted in duplicate and a coefficient of variation (CV) of less than 10% was required or new representative samples were analyzed. True DM of feces, orts, and TMR was determined by drying subsamples (0.9990-1.0100 g) for 24 h at 105° C. in a forced-air oven according to AOAC (1999) procedures. Organic matter (OM) was determined by ashing in a muffle furnace (Isotemp Muffle Furnace, Model 186, Fisher Scientific, Montreal, Quebec, Canada) for 4 h at 600° C. according to AOAC (1999) procedures. Neutral detergent fiber (NDF) and acid detergent fiber (ADF) analysis using sequential analysis utilizing an ANKOM²⁰⁰ Fiber Analyzer (ANKOM Technology, Macedon, N.Y.) was conducted using the methods of Van Soest et al. (1991). Alpha-amylase was used during the NDF analysis. Each run included a sample of Brome grass hay as a standard (average NDF was 80.10% and ADF was 45.40%) to verify intra-assay accuracy (intra-assay CV of 1.01% for NDF and 1.00% for ADF). Pooled urine samples, feces, orts, and TMR from each period were analyzed for N content by combustion (AOAC, 1990) using a Leco Tru-Mac (Leco Corporation, St. Joseph, Mich.). EDTA was used daily as a calibration standard. A sub-sample of feces, orts, and TMR were sent to the University of Arkansas Central Analytical Laboratory (Poultry Science Center, Fayetteville, Ark.) for ether extract (EE) analysis (AOAC, 1990, Official Methods of Analysis. 15th ed. Association of Official Analytical Chemists, Arlington, Va.).

Digestibility for all nutrients for each period was calculated on a true DM (105° C.) basis. Digestibility was calculated by subtracting the total output (total fecal output) from the total intake (total feed offered minus orts), dividing by total intake, and multiplying by 100 and data are reported as a percent. Nitrogen balance was calculated by subtracting the N excreted (N amount in urine and feces) from the N intake (N in feed minus N in orts) and data are reported in grams per day. Crude protein (CP) was calculated as N×6.25.

Data were analyzed by analysis of variance (ANOVA) using the Mixed procedure of SAS (SAS Institute, Inc., Cary, N.C.). The experimental unit for all analyses was individual lamb (n=8) and no lambs were removed from the trial. Period and treatment were considered fixed effects for dietary analysis and period, treatment, and lamb nested within square were considered fixed effects for digestibility, input, and output analysis. Three single degree of freedom contrast statements were constructed a priori: 1) control vs. the average of the treatments including delipidated algae (10, 20, and 30% delipidated algae), and 2) linear, and 3) quadratic effects of increasing inclusion of delipidated algae (0, 10, 20, and 30% DM of delipidated algae). Significance was declared at P≦0.05 and tendencies were declared at 0.06≦P≦0.10. Means are reported in the tables as LSMEANS and SEM.

The objective of this study was to determine the effects of replacing soyhulls with increasing inclusions of DMA on total tract nutrient digestibility in finishing lambs. Partially deoiled microalgae is a portion of algae meal that offers an attractive nutrient profile for ruminants; however, the utility of this feedstuff has yet to be determined. The ruminant serves as an ideal model to consume waste products with their unique ability to utilize fermentation to access energy from feedstuffs. Considering that the algae meal is composed of both DMA and soyhulls this study was designed to help separate the effects of the DMA and soyhulls, as soyhulls were directly replaced on a DM basis with increasing inclusions of DMA.

The analyzed nutrient composition of the experimental diets is reported in Table 14. Dry matter concentration was lesser (P=0.002) for control compared with diets containing DMA and there was a linear (P<0.001) increase in DM as the inclusion of DMA increased in the diet. This small change in DM was expected because the algae meal utilized in this experiment was 97.1±1.30% DM while it replaced ground soyhulls that were not as dry (89.5±1.16% DM). There was a quadratic (P=0.01) effect on OM concentration of the diets, likely driven by the lesser OM of the DMA20 diet. Both NDF and ADF concentrations were greater (P<0.001) for control than DMA-containing diets and there was a linear (P<0.001) decrease in these nutrients as DMA increased in the diet. Ether extract and nitrogen concentrations did not differ (P≧0.13) across diets. Non fibrous carbohydrate concentrations were lesser (P<0.001) for control than DMA-containing diets and linearly (P<0.001) increased as DMA inclusion increased in the diet.

Lamb DMI, OM intake (OMI), as well as fecal DM and OM output and urine output data are reported in Table 15. Neither DMI nor OMI differed (P≧0.14) between control and DMA-fed lambs, suggesting that palatability and preference are of minimal concern for this feedstuff. In the present trial, fecal DM and OM output did not differ (P≧0.90) between control and DMA-fed lambs. Urine output linearly (P=0.02) increased as DMA increased in the diet. It is important to note that in the current trial sorting and feed refusals were minimal in diets containing the DMA.

Lamb nutrient digestibility calculations are reported in Table 16. Both DM and OM digestibility were greater (P≦0.05) for control than DMA-fed lambs and linearly (P≦0.004) decreased as inclusion of DMA increased in the diet. Though not dramatic, the decreases in both DM and OM digestibility are likely driven by decreases in fiber digestibility as DMA replaced soyhulls in the diet. Neutral detergent fiber and ADF digestibility were greater (P<0.001) for control than DMA-fed lambs. Also, there was a quadratic (P≦0.04) effect for NDF and ADF digestibility as DMA inclusion increased in the diet. The lesser fiber digestion by DMA30-fed lambs likely drives this effect, as the other treatments displayed less acute decreases in fiber digestion compared to control-fed lambs. The algae meal has a calculated NFC concentration of 42.5%, while soyhulls have a NFC concentration of only 11.9%. This resulted in the NFC concentration increasing by over 15% from the control to the DMA30 diet. Non fibrous carbohydrate digestion did not differ (P=0.37) between control and DMA-fed lambs. Non fibrous carbohydrates often include rapidly fermentable starches and sugars and the diets containing DMA offered increased inclusions of NFC. The NFC content of the DMA appears to be a function of the compounds utilized in the media during algae growth and likely consists of a variety of fermentable sugars.

Concentrate feedstuffs provide increased quantities of easily fermentable carbohydrates, driving ruminal pH down due to the production of lactic acid and volatile fatty acids. This decreased pH can negatively affect cellulolytic bacteria populations and consequentially the digestibility of plant cell walls (Mould, F. L., E. R. Orskov, and S. O. Mann. 1983. Associative effects of mixed feeds. I. Effects of type and level of supplementation and the influence of the rumen fluid pH on cellulolysis in vivo and dry matter digestion of various roughages. Anim. Feed Sci. and Tech. 10:15-30). These negative associative effects are commonly noted in diets containing both grain and roughage. Shriver et al. (Shriver, B. J., W. H. Hoover, J. P. Sargent, R. J. Crawford Jr., and W. V. Thayne. 1986. Fermentation of a high concentrate diet as affected by ruminal pH and digesta flow. J. Dairy Sci. 69:413-419) reported that in a continuous culture system when a diet of 65% concentrate and 35% hay was provided pH dropped below 6.0 and resulted in a negative effect on fiber digestibility. The diet, utilized in the continuous culture system, may be most similar to the DMA30 diet fed in the current trial which contained 32.3% NDF and 46.2% NFC. This similarity suggests that the pH and thus fiber digestibility may have been negatively impacted in lambs fed this diet. Deoiled microalgae likely offers a variety of fermentable sugars due to the media utilized for algae growth and the fermentation of these sugars may have other effects on the rumen environment. A decreased pH may not be the only aspect of decreased fiber digestibility in a concentrate rich diet. Piwonka and Firkins (Piwonka, E. J., and J. L. Firkins. 1996. Effect of glucose fermentation on fiber digestion by ruminal microorganisms in vitro. J. Dairy Sci. 79:2196-2206) reported that a proteinaceous inhibitor was produced during glucose fermentation and inhibits fibrolytic organisms even when pH was maintained above 6.2 in mixed cultures. It has been reported on several occasions that supplementing cattle consuming forage based diets with pure starch or feeds containing high amounts of starch, such as corn, decreases fiber digestion (Joanning, S. W., D. E. Johnson, and B. P. Barry. 1981. Nutrient digestibility depressions in corn silage-corn grain mixtures fed to steers. J. Anim. Sci. 53:1095-1103; Chase, C. C., and C. A. Hibberd. 1987. Utilization of low-quality native grass hay by beef cows fed increasing quantities of corn grain. J. Anim. Sci. 65:557-566; and Olsen, K. C., R. C. Cochran, T. J. Jones, E. S. Vanzant, E. C. Titgemeyer, and D. E. Johnson. 1999. Effects of ruminal administration of supplemental degradable intake protein and starch on utilization of low-quality warm-season grass hay by beef steers. J. Anim. Sci. 77:1016-1025).

As DMA contains some residual oil this feedstuff should contribute to the energy density of diets; however, ether extract content of diets used in this study were balanced across treatments. Ether extract digestibility was not different (P=0.26) between control and DMA-fed lambs. Nitrogen digestibility linearly (P=0.05) decreased as DMA inclusion increased in the diet. Nitrogen balance was greater (P=0.01) for the control than DMA-fed lambs and linearly (P=0.004) decreased as DMA inclusion increased in the diet. This decrease in N digestibility and balance could once again simply be reflective of the negative associative effects between concentrate and fibrous feedstuffs. Cardozo et al. (Cardozo, P., S. Calsamiglia, and A. Ferrett. 2000. Effect of pH on microbial fermentation and nutrient flow in a dual flow continuous culture system. J. Dairy Sci. 83(Suppl. 1):265 and Cardozo, P., S. Calsamiglia, and A. Ferrett. 2002. Effects of pH on nutrient digestion and microbial fermentation in a dual flow continuous culture system fed a high concentrate diet. J. Dairy Sci. 85(Suppl. 1):182) reported in two continuous culture fermentation studies comparing high concentrate and high forage diets that when pH decreased from 7 to 4.9 protein degradation was decreased for both diet types. This ultimately can contribute to a lesser N digestibility, as reported in the present study. Diets containing greater amounts of starch tend to lead to more rapid starch fermentation and consequently increased acid production. Cellulolytic organisms tend to be less tolerant of these conditions and thus may decrease in number (Slyter, 1976). While proteolytic bacteria are less likely to be effected by decreases in pH (Endres and Stern, 1993), it is likely that protein degradation requires the presence of both proteolytic and nonproteolytic enzymes (Bach, A., S. Calsamiglia, and M. D. Stern. 2005. Nitrogen metabolism in the rumen. J. Dairy Sci. 88(E. Suppl.):E9-E21). This was clearly illustrated by Endres and Stern (Endres, M. I., and M. D. Stern. 1993. Effects of pH and diets containing various levels of lignosulfonate-treated soybean meal on microbial fermentation in continuous culture. J. Dairy Sci. 76(Suppl. 1):177) who reported a decrease in CP digestion when pH decreased from 6.3 to 5.9; however, while proteolytic bacteria counts were not affected by this decrease in pH, cellulolytic bacteria counts decreased about 50%. While microbial populations were not measured in the present study, bacterial population shifts as induced by feeding increasing amounts of DMA in place of soyhulls may aid in explaining the nutrient digestibility of these lambs.

Interestingly, though fiber and N digestibility were decreased as DMA increased in the diet, overall impacts on DM digestibility were relatively small. This is due largely to the similar NFC digestibility observed across diets and the fact that NFC make up a greater portion of algae meal containing diets. It is apparent based on these results that DMA acts more similarly to grain than non-roughage fiber in the ruminant and thus would be a logical replacement for concentrate feedstuffs such as corn.

In conclusion, the results of this study suggest that DMA is well digested by ruminants and will be readily consumed by lambs when included at up to 30% of the diet DM. The nutrient digestibility data suggest that DMA may be best utilized as a concentrate feed replacement and could serve as a viable component of feedlot diets. From a nutritional standpoint algae meal offers an attractive combination of protein, fiber, and fat. Changes in digestibility of specific nutrients with increasing inclusions at the expense of soyhulls suggest that DMA is more characteristic of a concentrate rather than a fibrous feedstuff.

TABLE 14
Analyzed nutrient composition of diets.

| | | Partially Deoiled | | | | P-value | | |
|---|---|---|---|---|---|---|---|---|
| | | Microalgae | | | | Control | | |
| | Control | 10% | 20% | 30% | SEM | vs. DMA | Linear | Quadratic |
| Dry matter | 76.54 | 76.69 | 77.31 | 77.83 | 0.146 | 0.002 | <0.001 | 0.23 |
| %, DM basis | | | | | | | | |
| Organic matter | 94.48 | 94.30 | 94.01 | 94.52 | 0.110 | 0.15 | 0.74 | 0.01 |
| NDF | 48.36 | 44.22 | 38.89 | 32.26 | 1.354 | <0.001 | <0.001 | 0.38 |
| ADF | 28.67 | 25.57 | 21.68 | 16.63 | 0.861 | <0.001 | <0.001 | 0.28 |
| Ether extract | 3.59 | 4.17 | 3.73 | 4.08 | 0.209 | 0.13 | 0.30 | 0.60 |
| Nitrogen | 1.92 | 1.96 | 1.93 | 1.92 | 0.018 | 0.51 | 0.78 | 0.26 |
| Crude protein | 12.02 | 12.23 | 12.09 | 12.02 | 0.115 | 0.51 | 0.78 | 0.26 |
| NFC¹ | 30.50 | 33.68 | 39.30 | 46.15 | 1.477 | <0.001 | <0.001 | 0.25 |

¹Non fibrous carbohydrate: calculated by the equation (100 − ash − crude protein − ether extract − NDF)

TABLE 15
Lamb intake and output calculations (% DM basis).

| | | Partially Deoiled | | | | P-value | | |
|---|---|---|---|---|---|---|---|---|
| | | Microalgae | | | | Control | | |
| | Control | 10% | 20% | 30% | SEM | vs. DMA | Linear | Quadratic |
| Lambs (n) | 8 | 8 | 8 | 8 | | | | |
| DMI, kg/d | 1.31 | 1.14 | 1.27 | 1.20 | 0.062 | 0.16 | 0.48 | 0.46 |
| OMI, kg/d | 1.24 | 1.08 | 1.20 | 1.14 | 0.058 | 0.14 | 0.47 | 0.41 |
| Daily output | | | | | | | | |
| Fecal, kg of DM/d | 0.36 | 0.32 | 0.37 | 0.38 | 0.025 | 0.90 | 0.34 | 0.37 |
| Fecal, kg of OM/d | 0.33 | 0.29 | 0.35 | 0.35 | 0.023 | 0.98 | 0.27 | 0.36 |
| Urine, L/d | 0.57 | 0.72 | 0.77 | 0.87 | 0.080 | 0.03 | 0.02 | 0.71 |

TABLE 16
Lamb diet digestibility calculations (% DM basis).

| | | | | | | P-value | | |
|---|---|---|---|---|---|---|---|---|
| | | Partially Deoiled | | | | Control | | |
| | | Microalgae | | | | vs. | | |
| | Control | 10% | 20% | 30% | SEM | DMA | Linear | Quadratic |
| Lambs (n) | 8 | 8 | 8 | 8 | | | | |
| DM digestibility, % | 72.73 | 72.09 | 70.34 | 68.43 | 1.005 | 0.05 | 0.004 | 0.53 |
| OM digestibility, % | 73.64 | 72.93 | 71.01 | 69.05 | 1.013 | 0.04 | 0.003 | 0.55 |
| NDF digestibility, % | 65.50 | 61.32 | 53.58 | 38.97 | 2.363 | <0.001 | <0.001 | 0.04 |
| ADF digestibility, % | 64.96 | 60.73 | 50.94 | 30.21 | 2.661 | <0.001 | <0.001 | 0.006 |
| Ether extract digestibility, % | 85.35 | 89.70 | 88.00 | 86.04 | 1.942 | 0.26 | 0.97 | 0.12 |
| N digestibility, % | 60.21 | 58.93 | 57.98 | 57.16 | 1.098 | 0.10 | 0.05 | 0.83 |
| N balance, g/d | 10.14 | 8.35 | 8.85 | 6.83 | 0.639 | 0.01 | 0.004 | 0.86 |
| NFC digestibility¹, % | 90.47 | 91.38 | 90.81 | 91.13 | 0.604 | 0.37 | 0.61 | 0.63 |

¹Non fibrous carbohydrate content of TMR, feces, and orts was calculated by the equation (100 − Ash − Crude Protein − Ether extract − NDF)

### Example 7

### Growth and Carcass Characteristics of Finishing Steers

De-oiled microalgae from large scale production of heterotrophic microalgae can be combined with soyhulls to form a novel feedstuff called algae meal (ALG). In this example, the algae meal was prepared by combining approximately 45% by weight soyhulls with approximately 55% microalgal biomass. The mixture was then pressed to partially remove oil resulting in a press cake having approximately 58% soy hulls and 42% partially delipidated microalgal biomass.

Angus-cross yearling steers (n=168) were purchased at the Unionville Livestock Market (Unionville, Mo.) from a single source. On d −20 steers were weighed, dewormed with Ivomec Eprinex Pour-On (Merial Animal Health, Duluth, Ga.), vaccinated with Bovi-shield GOLD 5 (Zoetis, New York, N.Y.), implanted with Component TE-IS with Tylan[80 mg trenbolone acetate (TBA), 16 mg estradiol, and 29 mg tylosin tartrate; donated by Elanco Animal Health, Greenfield, Ind.], and identified with a unique visual and electronic identification tag. Prior to the start of the trial steers received a common starting diet for 7 d, followed by three step-up diets that gradually replaced hay, dried distillers grains with solubles (DDGS), and wet distillers grains with solubles (WDGS) with corn and modified distillers grains with solubles (MDGS) in preparation for the finishing diet. Steers were re-implanted on d 56 with Component TE-S with Tylan[120 mg TBA, 24 mg estradiol, and 29 mg tylosin tartrate; donated by Elanco Animal Health, Greenfield, Ind.].

At the initiation of the study, individual steer weights were taken over 2 consecutive days and steers were blocked by initial BW (952.8±9.7 lbs) into pens (6 steers/pen and 7 pens/treatment) and randomly assigned to 1 of 4 treatments (Table 17): a corn-based control (CON), 14% algae meal (14% ALG), 28% algae meal (28% ALG), and 42% algae meal (42% ALG). Algae meal was added at the expense of dry rolled corn on a DM basis and all diets included 25.5% MDGS to add moisture to the diet. On d 99 through d 102 all steers received a common washout diet per FDA regulations for withdrawal from algae meal. Body weights were collected on d 28, 56, and 74. On day 74 ractopamine hydrochloride (Optaflexx, donated by Elanco Animal Health, Greenfield, Ind.) was added to the diet (300 mg·steer-1·d-1) and fed for the last 28 d of the trial. Final body weight was collected on 2 consecutive days prior to harvest.

TABLE 17
Ingredient composition of finishing steer diets (% DM basis).

| | | Algae meal | | | |
|---|---|---|---|---|---|
| Ingredient (% DM) | Control | 14% | 28% | 42% | Washout |
| Corn | 59.5 | 45.5 | 31.5 | 17.5 | 43.5 |
| MDGS¹ | 25.5 | 25.5 | 25.5 | 25.5 | 25.5 |
| Hay | 10 | 10 | 10 | 10 | 10 |
| Algae meal | — | 14 | 28 | 42 | — |
| Soyhulls | — | — | — | — | 16 |
| DDGS² | 2.96 | 2.96 | 2.96 | 2.96 | 2.96 |
| Limestone | 1.58 | 1.58 | 1.58 | 1.58 | 1.58 |
| Salt | 0.31 | 0.31 | 0.31 | 0.31 | 0.31 |
| Rumensin³ | 0.014 | 0.014 | 0.014 | 0.014 | 0.014 |
| Vitamin A premix⁴ | 0.11 | 0.11 | 0.11 | 0.11 | 0.11 |
| Trace mineral premix⁵ | 0.024 | 0.024 | 0.024 | 0.024 | 0.024 |

¹Modified distillers grains with solubles.
²Carrier for micro-ingredients
³Provided at 27 g/ton of diet DM
⁴Contained 4,400,000 IU/kg Vitamin A premix
⁵Provided per kilogram of diet DM: 10 mg of Cu (copper sulfate), 30 mg of Zn (zinc sulfate), 20 mg of Mn (manganese sulfate), 0.5 mg of I (calcium iodate), 0.1 mg of Se (sodium selenite), and 0.1 mg of Co (cobalt carbonate)

Feed was delivered to cattle daily at approximately 0800 h, and cattle had ad libitum access to water. Total feed offered and bunk scores were recorded daily. Bunks were managed to allow maximum feed intake. Samples of total mixed rations and ingredients were taken weekly to determine diet DM. Orts were weighed and sampled in conjunction with weigh dates and used to determine pen DM intake. Samples were dried in a forced air oven at 70° C. for 48 h. Feed conversion (feed:gain) was calculated for each weigh period from DMI and steer weight gain. Steers were harvested on d 102 when greater than 60% of steers were visually appraised to have at least 0.5 inches of backfat. Steers were harvested in Denison, Iowa at a commercial abattoir (Tyson Fresh Meats), and individual identification remained with each carcass following harvest. Carcasses were chilled for 24 h before being ribbed between the 12th and 13th ribs and graded according to USDA standards. Tri-County Carcass Futurity representatives (Iowa State University Beef Extension, Lewis, Iowa) collected carcass data at the plant and were blind to treatments. Data collected from harvested steers (n=167) included HCW, BF, KPH, REA, marbling score, yield grade (YG), and quality grade (QG). Carcass adjusted performance calculations utilized final BW determined by dividing HCW by the average dressing percent of 64%. A 4% shrink was applied to all live BW measurements before calculating ADG. One steer on the CON diet was removed from the trial due to death unrelated to treatment.

Data were analyzed using the MIXED procedure of SAS (SAS Inst. Inc., Cary, N.C.) and the experimental design was a randomized complete block. The model for performance and carcass characteristics included the fixed effects of the treatment and block. Dry matter intake, ADG, and G:F data were analyzed as repeated measures with the fixed effects of treatment, block, date, and the interaction between treatment and date. Pen served as the experimental unit for all analysis (n=7/treatment) and date was the repeated effect. Three single degree of freedom contrast statements were designed prior to the analysis of data: 1) CON vs ALG, 2) linear effect of ALG, and 3) quadratic effect of ALG. Significance was declared at P≦0.05, and tendencies were declared from 0.05<P≦0.10.

Steer performance results are presented in Table 18. Based on repeated measure analysis, DMI demonstrated a tendency for a treatment by date interaction (P=0.10). This tendency is likely caused by the quadratic effect (P=0.03) during d 29 to 56, with the CON cattle having lesser DMI, the 14% ALG steers have intermediate intakes, and the 28% and 42% ALG steers have the greatest and similar intakes. The repeat overall effect for DMI was lesser (P<0.001) for control than ALG steers and linearly increased (P<0.001) as algae meal increased in the diet. Repeated measures also revealed a treatment by date interaction for ADG (P=0.002). This effect on ADG is driven by several factors. On d 0 to 28 and d 57 to 74, ADG tended to be lesser (P≦0.07) for the CON then ALG steers and linearly decreased (P≦0.03) as ALG inclusion increased in the diet. However, on d 29 to 56, there was no effect of ALG inclusion on ADG. Contrary to all other dates, from d 74 to 102, ADG was lesser (P<0.001) for CON than ALG and linearly increased (P<0.001) as ALG increased in the diet. Overall, algae meal inclusion had no effect on final BW (P=0.76). Also, based on repeated measures analysis there was a treatment by date interaction for F:G (P=0.004). This interaction is largely driven by the changes in ADG over time. On d 0 to 28, 29 to 56, and 57 to 74, F:G was lesser (P≦0.02) for the CON than ALG steers and linearly increased (P≦0.02) as ALG increased in the diet. However, similar to ADG the opposite occurred from d 75 to 102 as F:G was greater (P=0.01) for the CON than ALG steers and linearly decreased (P=0.006) as ALG increased in the diet.

TABLE 18
Effect of increased inclusions of algae meal on BW, gain, and efficiency of
finishing steers.

| | | | | | | P-value | | |
|---|---|---|---|---|---|---|---|---|
| | | Algae meal | | | | Control vs | | |
| | Control | 14% | 28% | 42% | SEM | ALG | Linear | Quadratic |
| Live Performance | | | | | | | | |
| Initial BW,⁴ lbs | 952 | 950 | 953 | 958 | 5.3 | 0.76 | 0.40 | 0.56 |
| Final BW,⁴ lbs | 1357 | 1353 | 1356 | 1354 | 6.4 | 0.74 | 0.89 | 0.83 |
| DMI¹ lbs/d | 27.91 | 29.64 | 30.52 | 31.69 | 0.323 | <0.001 | <0.001 | 0.39 |
| d 0 to 28 | 27.45 | 28.61 | 29.26 | 30.08 | 0.528 | 0.008 | 0.003 | 0.74 |
| d 29 to 56 | 28.19 | 30.34 | 31.88 | 32.22 | 0.390 | <0.001 | <0.001 | 0.03 |
| d 57 to 74 | 27.84 | 30.01 | 30.82 | 32.29 | 0.425 | <0.001 | <0.001 | 0.43 |
| d 75 to 102 | 28.31 | 29.70 | 30.38 | 32.05 | 0.406 | <0.001 | <0.001 | 0.72 |
| ADG², lbs/d | 3.98 | 3.91 | 3.95 | 3.91 | 0.087 | 0.60 | 0.66 | 0.90 |
| d 0 to 28 | 4.58 | 4.29 | 4.13 | 3.75 | 0.232 | 0.07 | 0.03 | 0.86 |
| d 29 to 56 | 4.19 | 4.17 | 4.17 | 4.17 | 0.151 | 0.93 | 0.95 | 0.95 |
| d 57 to 74 | 4.24 | 4.06 | 3.50 | 3.67 | 0.178 | 0.03 | 0.01 | 0.36 |
| d 75 to 102 | 3.54 | 3.78 | 4.30 | 4.30 | 0.114 | <0.001 | <0.001 | 0.30 |
| F:G³ | 7.03 | 7.49 | 7.73 | 8.15 | 0.142 | <0.001 | <0.001 | 0.91 |
| d 0 to 28 | 6.28 | 6.98 | 7.46 | 8.49 | 0.369 | 0.006 | <0.001 | 0.64 |
| d 29 to 56 | 7.05 | 7.70 | 8.06 | 8.15 | 0.323 | 0.02 | 0.02 | 0.40 |
| d 57 to 74 | 6.93 | 7.88 | 9.36 | 9.33 | 0.480 | 0.003 | <0.001 | 0.32 |
| d 75 to 102 | 8.03 | 7.92 | 7.09 | 7.55 | 0.162 | 0.01 | 0.006 | 0.10 |
| Carcass adjusted | | | | | | | | |
| performance⁵ | | | | | | | | |
| Final BW, lbs | 1360 | 1357 | 1357 | 1348 | 7.3 | 0.50 | 0.30 | 0.70 |
| ADG, lbs/d | 4.00 | 3.96 | 3.96 | 3.83 | 0.080 | 0.41 | 0.20 | 0.60 |
| F:G | 7.00 | 7.43 | 7.82 | 8.27 | 0.147 | <0.001 | <0.001 | 0.96 |

¹Treatment by date (P = 0.10)
²Treatment by date (P = 0.002)
³Treatment by date (P = 0.004)
⁴A 4% shrink was applied to live body weights
⁵Carcass adjusted performance values are based on final PW calculated from HCW divided by the average dressing percent of 64%; A 4% shrink was applied to initial live weights

Carcass characteristics are presented in Table 19. Hot carcass weight, REA, marbling score, and quality grade were not affected (P≧0.14) by ALG inclusion. This suggests that cattle performed similarly when ALG replaced corn in diets. There was a tendency for a linear decrease (P=0.10) in dressing percent, because of the lesser dressing percent of the 42% ALG cattle. There was also a tendency for a linear decrease (P=0.08) in 12th rib back fat, once again due to the lesser back fat of the 42% ALG cattle. Percentage of KPH fat was greater (P<0.02) for control than all the ALG steers and linearly decreased (P<0.02) as ALG increased in the diet. Yield grade also linearly decreased (P<0.02) as ALG inclusion increased in the diet. This is due to the lesser yield grade of the 42% ALG steers. Total lipid, SFA, MUFA, and PUFA concentrations in the longissimus thoracis did not differ (P≧0.13) between CON and ALG-fed cattle. It appears ALG has approximately 85% of the energy value of dent corn; however, minimal effect on carcass performance indicates ALG can serve as a replacement for corn in feedlot diets.

TABLE 19
Effect of increased inclusions of algae meal on carcass characteristics of
finishing steers.

| | | | | | | P-value | | |
|---|---|---|---|---|---|---|---|---|
| | | Algae meal | | | | Control vs | | |
| | Control | 14% | 28% | 42% | SEM | ALG | Linear | Quadratic |
| HCW, lbs | 873 | 871 | 871 | 866 | 4.7 | 0.50 | 0.30 | 0.70 |
| Dressing percent | 64.3 | 64.4 | 64.2 | 63.9 | 0.19 | 0.45 | 0.10 | 0.32 |
| 12^{th}-rib back fat, in | 0.61 | 0.59 | 0.61 | 0.54 | 0.021 | 0.29 | 0.08 | 0.24 |
| KPH, % | 2.60 | 2.49 | 2.50 | 2.42 | 0.043 | 0.02 | 0.02 | 0.81 |
| REA, in² | 13.5 | 13.4 | 13.5 | 13.5 | 0.17 | 0.79 | 0.94 | 0.65 |
| Yield grade | 3.25 | 3.19 | 3.19 | 2.88 | 0.100 | 0.17 | 0.02 | 0.23 |
| Marbling score² | 448 | 460 | 469 | 451 | 10.3 | 0.32 | 0.70 | 0.17 |
| Quality grade² | 2.95 | 3.07 | 3.17 | 2.95 | 0.108 | 0.38 | 0.85 | 0.14 |

¹Marbling scores: slight: 300, small: 400, modest: 500
²Quality grade: 2: Select⁺, 3: Choice, 4: Choice

TABLE 20
Effect of algae meal on fatty acid percentages and ratios of the longissimus
thoracis collected from steers.

| | | | | | | P-value | | |
|---|---|---|---|---|---|---|---|---|
| | | Algae meal | | | | Control | | |
| | Control | 14% | 28% | 42% | SEM | vs ALG | Linear | Quadratic |
| SFA, %¹ | 44.22 | 42.72 | 43.74 | 42.00 | 0.759 | 0.13 | 0.11 | 0.88 |
| MUFA, %² | 43.64 | 43.78 | 44.73 | 44.82 | 1.072 | 0.52 | 0.36 | 0.98 |
| PUFA, %³ | 7.77 | 7.87 | 7.23 | 8.20 | 0.758 | 1.00 | 0.85 | 0.57 |
| PUFA:SFA | 0.176 | 0.188 | 0.166 | 0.200 | 0.0219 | 0.75 | 0.62 | 0.62 |
| n3, %⁴ | 1.149 | 0.550 | 0.632 | 0.741 | 0.2232 | 0.06 | 0.27 | 0.13 |
| n6, %⁵ | 6.28 | 6.99 | 6.24 | 7.15 | 0.762 | 0.57 | 0.59 | 0.89 |
| n6:n3 | 15.31 | 25.97 | 17.09 | 15.01 | 3.615 | 0.35 | 0.55 | 0.10 |
| AI⁶ | 0.710 | 0.663 | 0.660 | 0.610 | 0.0212 | 0.02 | 0.005 | 0.92 |
| Other, %⁷ | 4.42 | 5.59 | 4.30 | 4.98 | 0.713 | 0.52 | 0.91 | 0.73 |
| Lipid, %⁸ | 4.13 | 4.54 | 4.51 | 3.95 | 0.588 | 0.77 | 0.83 | 0.42 |

¹Saturated fatty acid calculation, sum of C10:0, C12:0, C13:0, C14:0, C15:0, C16:0, C17:0, C18:0, C20:0, C22:0, C23:0, C24:0.
²Monounsaturated fatty acid calculation, sumof: C14:1n5, C16:1n7, C17:1n9, C18:1t6 & t9, C18:1t10, C18:1t11, C18:1t12, C18:1t15, C18:1c9, C18:1c11, C18:1c12, C18:1c13, C20:1n11.
³Polyunsaturated fatty acid calculation, sum of: C18:2n6, C18:3n3, C18:3n6, C20:2n6, C20:3n6, C20:3n3, C20:4n6, C20:5n3, C22:5n3, C22:6n3, c9-t11 CLA.
⁴Omega 3 fatty acid calculation, sum of: C18:3n3, C20:3n3, C20:5n3, C22:5n3, and C22n3.
⁵Omega 6 fatty acid calculation, sum of: C18:2n6, C18:3n6, C20:2n6, C20:3n6, and C20:4n6.
⁶Atherogenic index is calculated: ((C12:0 + (4 * C14:0) + C16:0)/(% MUFA + % PUFA)).
⁷Indicates the percent of unidentified peaks.
⁸Percent lipid of steaks from fatty acid extraction

The unique nutrient profile of the algae meal used in this study suggest that it has great potential as a competitive feedstuff in ruminant diets. Our objective was to examine the effects of algae meal on live and carcass-based performance of feedlot steers. Because the algae meal is so dry, modified distillers grains were included in the total mixed ration to lessen sorting and assure good intakes. It is important to note, that as seen in previous studies, palatability was not an issue and steers readily consumed algae meal with minimal to no sorting. Overall algae meal did not affect final BW or HCW which allows us to conclude that algae meal can replace corn without affecting steers ability to gain body weight. However, those steers fed algae meal had increased DMI across the entire trial. While this proves once again that palatability is not a negative issue, steers fed algae meal ultimately had to consume more to gain the same as their corn fed counterparts. Therefore we can conclude that algae meal has a lesser energy value than corn. Additionally, increasing inclusion of algae meal at up to 42% of the diet did not impact ribeye area, marbling scores or quality grade of the cattle, which is important to producers choosing to sell cattle on a value base grid that rewards better marbling scores and discounts cattle with poorer quality grades. Interestingly, backfat and yield grade of cattle was decreased in the 42% algae meal cattle, meaning that these cattle still achieved a good marbling score while having a lesser amount of undesirable backfat. The lower the yield grade the greater the premium for cattle producers, as a high yield grade is indicative of less lean meat yield and more fat. It appears that feeding algae meal will have limited impacts on carcass characteristics when compared to corn-fed cattle.

Even though final BW and HCW were not different due to diets, an interesting pattern of growth and feed conversion was noted in this study based on the live weights collected throughout. Both ADG and F:G data display a treatment by time interaction. It is important to note that on d 28, 56, and 74 only single day BW were collected, therefore gut fill may contribute to some differences among treatments. For the period of d 0-28 and 56-74 the corn fed control steers had greater ADG and consumed less feed than those fed any amount of algae meal, therefore these steers also had the more ideal feed conversion. No differences in ADG were noted among treatments from d 28-56; however, feed conversion was still better in corn-fed cattle. However, this effect was completely reversed in the last 28 days of the trial. During this period ADG was greater for the algae meal fed steers, and even though these steers still had the greater DMI their feed conversion was lesser and more ideal than the corn fed control steers. In fact, during the final 28 days of the trial the best feed conversion was observed in steers fed 28% algae meal. During the last 28 days of the trial all steers were also fed the beta-agonist ractopamine hydrochloride (Optaflexx). Beta-agonists are non-hormonal compounds that when fed to cattle reduce and redirect the metabolism of fat while simultaneously increasing muscle fiber size. This allows for increased efficiency and a carcass with a higher percentage of lean muscle while still not affecting the overall ability of the carcass to grade choice. Since the beta-agonist was fed to all cattle during the last 28 d on trial it is not possible to separate the effects of algae meal from that of the beta agonist. During the Optaflexx feeding period the cattle receiving algae meal outgained the control cattle considerably, to the point that while they entered the final 28 days on feed weighing less than the control cattle they exited the trial with nearly identical final body weights. It is unknown if the same trend would have been observed without the beta agonist in the diet. It is possible that there may be some synergistic effect between the beta agonist and algae meal. Whether this is due to the stage of growth or the synergy with growth technologies, further research is needed to evaluate this interaction.

The results of this study thus indicates that algae meal with its unique combination of protein, fiber, and fat can serve as a replacement for corn in feedlot diets with minimal effect on live and carcass based performance.

1. A method for providing feed to an animal, the method comprising administering to the animal a feed comprising up to 65% microalgae meal, wherein the microalgae meal comprises delipidated microalgal biomass.

2. The method of claim 1, wherein the feed comprises up to 45% microalgae meal.

3. The method of claim 2, wherein the feed comprises from 15% to 45% microalgae meal.

4. The method of claim 1, wherein the feed further comprises protein additives derived from non-microalgal sources.

5. The method of claim 4, wherein the protein additive is yeast or hydrolyzed yeast.

6. The method of claim 1, wherein the animal is a ruminant.

7. The method of claim 1, wherein the animal is cattle, swine, poultry, sheep, goat, or a companion animal such as a horse, rabbit, or dogs.

8. The method of claim 7, wherein the animal is cattle.

9. A method for increasing feed intake and weight gain in an animal, the method comprising administering to the animal a feed comprising up to 65% microalgae meal, wherein the microalgae meal comprises delipidated microalgal biomass, and wherein the feed intake increases with increasing microalgae meal content.

10. The method of claim 9, wherein the feed comprises up to 45% microalgae meal.

11. The method of claim 10, wherein the feed comprises from 15% to 45% microalgae meal.

12. The method of claim 9, wherein the feed further comprises protein additives derived from non-microalgal sources.

13. The method of claim 12, wherein the protein additive is yeast or hydrolyzed yeast.

14. The method of claim 9, where the weight gain is daily weight gain.

15. The method of claim 9, wherein the animal is a ruminant.

16. The method of claim 9, wherein the animal is cattle, swine, poultry, sheep, goat, or a companion animal such as a horse, rabbit, or dog.

17. The method of claim 16, wherein the animal is cattle.

18. The method of claim 17, wherein the animal is a calf.

19. The method of claim 1, wherein the feed further comprises corn, soybean, DDGS (dried distiller's grain with solubles), or one or more combinations thereof.

20. The method of claim 1, wherein the feed comprises at least 5%, 4%, 3%, or 2% moisture.

21. The method of claim 1, wherein the feed further comprises wet corn gluten feed, wet distillers grains, modified distillers grains, or one or more combinations thereof.

22. The method of claim 1, wherein the microalgae biomass is derived from a heterotrophically cultured microalgae.

23. The method of claim 22, wherein the microalgae is of the genus Prototheca.

24. The method of claim 23, wherein the microalgae is of the species Prototheca moriformis.

25. The method of claim 1, wherein the animal feed is a pellet.

26. The method of claim 1, wherein the microalgae meal further comprises corn starch, potato starch, cassava starch, switchgrass, rice straw, rice hulls, sugar beet pulp, sugar cane bagasse, soybean hulls, dry rosemary, cellulose, corn stover, delipidated cake from soybean, canola, cottonseed, sunflower, jatropha seeds, paper pulp, or waste paper.

27. The method of claim 26, wherein the microalgae meal further comprises soybean hulls.

28. The method of claim 27, wherein the soybean hulls comprise 5 to 50% by weight of the microalgae meal.

29. The method of claim 27, wherein the soybean hulls comprise 25 to 45% by weight of the microalgae meal.

30. The method of claim 1, wherein the animal has a lower atherogenic index than when fed on corn.

31. The method of claim 1, wherein the microalgae meal comprises from 35% to 85% non-starch carbohydrates.

32. The method of claim 1, wherein the microalgae meal comprises from 35% to 45% non-starch carbohydrates.

33. The method of claim 1, wherein the microalgae meal comprises from 70% to 85% non-starch carbohydrates.

34. The method of claim 1, wherein the microalgae meal comprises from 5% to 15% fat.

35. The method of claim 1, wherein the microalgae meal comprises from 4% to 15% protein.

36. The animal feed or microalgae meal of claim 1.
